(19) United States
(12) Patent Application Publication
(10) Pub. No.: US 2018/0055142 A1
(43) Pub. Date: Mar. 1, 2018

(54) FOAMS, FOAMABLE COMPOSITIONS AND METHODS OF MAKING INTEGRAL SKIN FOAMS

(71) Applicant: HONEYWELL INTERNATIONAL INC., MORRIS PLAINS, NJ (US)

(72) Inventors: Bin Yu, Buffalo, NY (US); David John Williams, Buffalo, NY (US)

(21) Appl. No.: 15/558,035

(22) PCT Filed: Mar. 14, 2016
(86) PCT No.: PCT/US16/22391

§ 371 Date: Sep. 13, 2017

Related U.S. Application Data
(63) Continuation-in-part of application No. 15/066,866, filed on Mar. 10, 2016.
(60) Provisional application No. 62/132,804, filed on Mar. 13, 2015.

(51) Int. Cl. A43B 13/04; A43B 13/02; A43B 13/18; C08J 9/34; C08J 9/14; C08G 18/08

(52) U.S. Cl. CPC A43B 13/04; A43B 13/023; A43B 13/187; C08J 9/34; C08J 9/144; C08J 9/146; C08G 2101/0033; C08J 9/149; C08G 18/14; C08J 2203/162; C08J 2205/052; C08J 2203/12; C08J 2203/142; C08J 9/142

(57) ABSTRACT

The present invention relates, at least in part, to integral skin foam premix compositions, foams, and method of producing such foams. In certain aspects, the premix is storage stable and includes a hydrohaloolefin blowing agent, one or more polyols, one or more surfactants, and a catalyst.

### CROSS REFERENCE TO RELATED APPLICATIONS

The present application is the U.S. National Stage of PCT Application No. PCT/US16/22391 filed Mar. 14, 2016, which application is related to and claims the priority benefit as a continuation in part of each of U.S. Provisional Application 62/132,804, filed Mar. 13, 2015, now expired, and U.S. application Ser. No. 15/066,866, filed Mar. 10, 2016, now pending, each of which is incorporated herein by reference.

### FIELD OF THE INVENTION

This invention relates to integral skin foams and compositions, methods and systems having utility in forming integral skin foams, including integral skin foams used in shoe sole applications.

### BACKGROUND

Integral skin foams are well-known foams, typically polyurethane and/or polyisocyanurate foams, which have a specialized structure comprising a relatively low density, celluar portion (sometimes referred to herein as the “cushion portion” integrally connoted to a relatively high density, typically microcelluar portion located a surface of the foam (sometimes referred to herein as the “skin portion.”) Such specialized foam types are commonly used, for example, in the manufacture of certain automotive interior components and in the manufacture of shoe soles, in large part because the skin provides a cosmetically acceptable appearance while also providing enhanced resistance to abrasion and cracking.

Integral skin foams are typically prepared by reacting an organic polyisocyanate with a substance having at least one isocyanate reactive group, such as a polyol. The reaction is typically performed in the presence of catalyst, blowing agent, surfactant, and a variety of optional additives. It is typically carried out in a mold where a higher density skin forms at the interface of the reaction mixture and the relatively cool inner surface of the mold.

Many materials have been used as blowing agents in polyurethane foams including certain hydrocarbons, fluorocarbons, chlorocarbons, chlorofluorocarbons, hydrochlorofluorocarbons, halogenated hydrocarbons, ethers, esters, acetals, aldehydes, alcohols, ketones, inert gases, such as CO₂-generating materials, such as water or organic acids. Heat is generated when the polyisocyanate reacts with the polyol, and volatilizes the blowing agent contained in the liquid mixture, thereby forming bubbles. In the case of gas generating materials, gaseous species are generated by thermal decomposition or reaction with one or more of the ingredients used to produce the polyurethane foam. As the polymerization reaction proceeds, the liquid mixture becomes a cellular solid having a mostly closed cells which entrapat the blowing agent or certain components of blowing agent in the closed cells of the low density portion of the foam. In many, but not all, integral skin foam applications, a surfactant is used in the foaming composition in order to help in the formation of regular sized and shaped cells.

The formation of foams generally is disclosed, for example, in U.S. Pat. No. 8,420,706, which is assigned to the assignee of the present application and which is incorporated herein by reference. Numerous types of foam are disclosed, including closed cell foam, open cell foam, rigid foam, flexible foam, integral skin and the like. Also numerous blowing agents are disclosed, including numerous hydrohaloolefins. There is no disclosure or suggestion that an advantage could be achieved by judicious selection from among the disclosed blowing agents, or in particular amounts/concentrations, for use in connection with the formation of integral skin foams.

US Patent Application 2010/0216904 discloses foam-forming compositions comprising a blowing agent comprising a mixture of 2-chloro-3,3,3-trifluoropropene (HCFC-1233xf) and at least one additional hydrofluoroolefin. The additional hydrofluoroolefin can be selected from a very large list of compounds. The patent application indicates that all kinds of expanded polyurethane foams can be formed, including, integral skin, RIM and flexible foams, and in particular rigid closed-cell polymer foams useful in spray insulation, as pour-in-place appliance foams, or as rigid insulating board stock and laminates. There is no disclosure or suggestion that an advantage could be achieved by judicious selection from among the disclosed blowing agents, or in particular amounts/concentrations, for use in connection with the formation of integral skin foams.

The foam industry has historically used liquid chemical blowing agents because of their ease of use and ability to produce foams with superior mechanical properties, with water being typically used in the formation of integral skin foams. Water, like other chemical blowing agents, reacts as part of the foaming reaction and serves a blowing agent as a result of the chemical reaction forming gaseous materials that produce a celluar structure in the foam. The use of water as a blowing agent can help to maintain a relatively low density in the cushion portion of integral skin foam. However, applicants have come to appreciate that increasing the water above certain levels in certain situations, as explained in further detail below, can sometimes result in thin skin, poor abrasion resistance, poor tensile strength/tear strength, high compression set, high void and other defects on the foam surface. In addition, applicants have found that the use of certain physical blowing agents, particularly when combined with a carefully selected amount of a chemical blowing agent, can provide integral skin foam products with an unexpectedly advantageous combination of physical properties, especially for applications involving formation of shoe soles.

It is convenient in many applications to provide the components for polyurethane foams in pre-blended formulations. Typically, the foam formulation is pre-blended into two components. The polyisocyanate and optionally isocyanate compatible raw materials, including but not limited to certain blowing agents and non-reactive surfactants, can comprise the first component, which is sometimes referred to herein for convenience as the ISO component. A polyol or mixture of polyols, one or more surfactants, one or more catalysts, one or more blowing agents, and other optional components including but not limited to flame retardants, colorants, compatibilizers, and solubilizers comprise the second component, which is sometimes referred to herein for convenience as the POLYOL component or the polyol premix. Optionally, catalysts, crosslinker, surfactant, water and other additive can be blended together as a third component which can be blended with the POLYOL component. The polyurethane or polyisocyanurate foams are readily prepared by bringing together the ISO component and the POLYOL components together, either by hand mixing for small preparations and, preferably, by machine mixing techniques to form blocks, slabs, laminates, pour-in-place panels and integral skin foams. Optionally, other ingredients such as fire retardants, colorants, antistatic agents, UV stabiilizers, auxiliary blowing agents, and other polyols can be added to the mixing head or reaction site. Most conveniently, however, they are ail incorporated into one POLYOL component.

Normally when foam is produced by bringing together the ISO component and the POLYOL components, a good foam is obtained. However, if the polyol premix composition is aged, prior to treatment with the polyisocyanate, applicants have come to appreciate that it is possible for the foams to be of lower quality and may even collapse during the formation of the foam.

Applicants have thus come to appreciate a need for compositions, and particularly blowing agents, foamable compositions, foamed articles and methods and systems for forming foam, particularly integral skin foams and particularly shoe soles, which provide beneficial properties and/or avoid one or more of the disadvantages noted above.

### SUMMARY

One preferred aspect of the present invention provides advantageous integral skin foams comprising:

(a) a substantially non-cellular, relatively high density polyurethane skin; and

(b) a substantially closed-cell, relatively low-density polyurethane foam core integrally attached to said skin, said closed-cells of said core containing blowing agent comprising physical blowing agent comprising, preferably in major proportion by weight, of one or more trifluoro, monochloropropenes (HFO-1233) (including all isomers, particularly HFO-1233xf and transHFO-1233zd and/or hexafluorobutenes, including all isomers of HFO-1336, particularly 1,1,1,4,4,4-hexafluoropropene (preferably cis1,1,1,4,4,4-hexafluoropropene (HFO-1336mmz(Z) in certain embodiments). In preferred embodiments of this aspect of the invention the foam has a core density of not greater than about 20 pounds per cubic foot (pcf), more preferably not greater than about 15 pcf and even more preferably not greater than about 10, and the skin layer has a Shore A hardness of not less than about 35, more preferably not less than about 40. In certain embodiments in which the physical blowing agent consists essentially of transHFO-1233zd, the foam preferably has a core density of not greater than about 15 pcf and the skin layer has a Shore A hardness of not less than about 45, and preferably not less than about 50.

As used herein, the terms “relatively high density” and “relatively low density,” when used together with reference to ISF and to shoe sole foam are used in a relative sense to designate the relative densities in the skin portion compared to the density in the core portion.

Another preferred aspect of the present invention provides advantageous shoe soles formed from or comprising an integral skin foam comprising:

(a) a substantially non-cellular, relatively high density polyurethane skin; and

(b) a substantially closed-cell, relatively low-density polyurethane foam core integrally attached to said skin, said closed-cells of said core containing blowing agent comprising: (i) physical blowing agent comprising, preferably in major proportion by weight, of one or more trifluoro,monochloropropenes (HFO-1233) and/or hexafluorobutenes, including all isomers of HFO-1336, particularly 1,1,1,4,4,4-hexafluoropropene (preferably cis1,1,1,4,4,4-hexafluoropropene (HFO-1336mmz(Z). In these and other preferred embodiments of shoe soles of the present invention, the integral skin foam has an overall density (skin plus core) of not greater than about 25 pounds per cubic foot (pcf), more preferably not greater than about 20 pcf, more preferably not greater than about 15 pcf and even more preferably not greater than about 10 pcf, and the skin layer has either: (i) a Shore C hardness of not less than about 75, more preferably not less than about 77.5; or (ii) a Shore A hardness of not less than about 35, more preferably not less than about 30, more preferably not less than about 35, and even more preferably not less than about 40.

In certain embodiments in which the physical blowing agent consists essentially of transHFO-1233zd, the integral skin foam, and in particular the shoe sole of the present invention, has a core density of not greater than about 25 pcf, more preferably not greater than about 20 pcf, and in an overall density of not greater than 18 pcf, more preferably not greater than 16 pcf, and preferably a rebounding percentage of not less than about 29%, more preferabaly not less than about 32% and even more preferably not less than 33%.

In certain embodiments in which the physical blowing agent consists essentially of transHFO-1233zd, the integral skin foam, and in particular the shoe sole of the present invention, has a core density of not greater than about 25 pcf, more preferably not greater than about 20 pcf, and in an overall density of not greater than 18 pcf, more preferably not greater than 16 pcf, and preferably a compression set (25%, 22 hours, 70° C.) that is at least about 30% below, more preferably at least about 40% less than the compression set of a foam made with the same method and formulation, expect with water substituted on an equal mole basis as the blowing agent in place of transHFO-1233zd. In certain aspects of such embodiments, the compression set (25%, 22 hours, 70° C.) is not greater than about than about 15, more preferably not greater than about 12, and even more preferably not greater than about 10.

In certain embodiments in which the physical blowing agent consists essentially of transHFO-1233zd, the integral skin foam, and in particular the shoe sole of the present invention, has a core density of not greater than about 25 pcf, more preferably not greater than about 20 pcf, and in an overall density of not greater than 18 pcf, more preferably not greater than 16 pcf, and preferably a elongation at break (as measured by DIN 53504) that is at least about 20% greater than, more preferably at least about 40% greater than, and even more preferably at least about 50% greater than the elongation of a foam made with the same method and formulation, expect with water substituted on an equal mole basis as the blowing agent in place of transHFO-1233zd. In certain aspects of such embodiments, the elongation at break (as measured according to DIN 53504) is not less than about 800, more preferably not less than about 900, and even more preferably no less thank about 1000.

Applicants have surprisingly found that integral skin foams having the above-noted combination of physical properties can be formed from preferred foamable compositions according to the present invention, preferably when formed using the preferred methods of the present invention. In preferred aspects the present invention provides foamable composition comprising:

(i) polyol component comprising one or more polyether polyols having: (a) an average functionality of from about 2 to about 4, more preferably of from about 2 to about 3; (b) an OH number (average) of from about 20 to about 35, more preferably from about 25 to about 30; and optionally but preferably an average molecular weight of from about 3000 to about 8000, more preferably from about 3500 to about 7000;

(ii) isocyanate component comprising one or more isocyanates with an NCO % of from about 18 to about 24, more preferably from about 18 to about 22, wherein the amount of said isocuyanate is preferably present in amount relative to the polyol to provide an index of from about 80 to about 120;

(iii) blowing agent comprising (a) chemical blowing agent preferably comprising at least about 90% water, and even more preferably about 100% water; and (b) and physical blowing agent comprising, preferably in major proportion by weight, of one or more trifluoro,monochloropropenes (HFO-1233).

In preferred embodiments the integral skin foams of the present invention have a tensile strength of from about 15 to 20 N/mm.

In preferred embodiments the integral skin foams of the present invention have a elongation of from about 850 to about 1100%.

In preferred embodiments the integral skin foams of the present invention have a tear strength of at least about 15.5 N/mm, more preferably at least about 16.5 N/mm. In preferred embodiments the integral skin foams of the present invention have a tear strength of from about 16.5 to about 25 N/mm, and even more preferably from about 16.5 to about 20 N/mm.

In preferred embodiments the integral skin foams of the present invention have a compression set of not greater than 15, more preferably not greater than about 10.

As used herein, hardness (Shore A or Shore C) refers to and is determined in accordance with the descriptions contained in ASTM D2240 as of the time of the filing of the present application.

As used herein, tensile strength and elongation refers to and is determined in accordance with the descriptions contained in ASTM D5035 as of the time of the filing of the present application.

As used herein, tear strength refers to and is determined in accordance with the descriptions contained in ASTM D2262 as of the time of the filing of the present application.

As used herein, compression set refers to and is determined in accordance with the descriptions contained in ASTM D395 (measured at 25%, 22 hours and 70° C.) as of the time of the filing of the present application.

As used herein, rebounding refers to and is determined in accordance with the descriptions contained in ASTM D3574 as of the time of the filing of the present application.

As used herein, energy absorption and impact resistance/compression resistance refers to and is determined in accordance with the descriptions contained in ISO 20344:2011 as of the time of the filing of the present application.

One aspect of the present invention comprises provides shoe soles, and footware that includes shoe soles, wherein the shoe sole comprises integral skin foams of the present invention.

Another aspect of the present invention comprises methods of forming molded integral skin foam comprising:

providing a foamable composition comprising: (a) one or more polyols, preferably polyol having a functionality of about 3 and/or a molecular weight of from about 500 to about 4500; (b) at least one isocyanate reactive with said polyols; (c) at least one chain extender; (d) one or more surfactants; (e) a catalyst; and (f) at least one physical blowing agent comprising, preferably in major proportion by weight, one or more fluorochloropropenes and/or hexafluorobutenes, including preferably that the fluorochloropropene, when present, includes one or more trifluoro,monochloropropenes (HFO-1233); and (g) optionally but preferably a chemical blowing agent, preferably water; and

molding said foamable composition in an integral skin foam having (i) a substantially non-cellular, relatively high density polyurethane skin; and (ii) a substantially closed-cell, relatively low-density polyurethane foam core integrally attached to said skin, said closed-cells of said core containing at least said physical blowing agent, wherein said foam has a core density of not greater than about 20 pounds per cubic foot (pcf), more preferably not greater than about 15 pcf and even more preferably not greater than about 10, and the skin layer has a Shore A hardness of not less than about 35, more preferably not less than about 40. In certain embodiments of this aspect of the invention, preferably those embodiments in which the physical blowing agent consists essentially of transHFO-1233zd, the foam has a core density of not greater than about 15 pcf and the skin layer has a Shore A hardness of not less than about 45, and preferably not less than about 50.

Preferably the integral skin foams of the present invention, and the foamable compositions used in the present methods of forming integral skin foams, comprise: (i) from about 0% to about 50% by weight, preferably from 20% to about 40% by weight of chemical blowing agent; and (ii) from about 50% to 100%, more preferably from about 60% to about 80% of physical blowing agent. It is also generally preferred that the physical blowing agent comprising at least about 50% by weight, more preferably at least about 60% by weight, and even more preferably at least about 80% by weight of trifluoro,monochloropropene(s) (such as trifluoro,monochloropropenes (HFO-1233)), and even more preferably CF₃CCl═CH₂ (HFO-1233xf) and CF₃CH═CHCl (HFO-1233zd)), including particularly transHFO-1233zd.

The term “HFO-1233” is used herein to refer to all trifluoro,monochloropropenes. Among the trifluoro,monochloropropenes are included 2-chloro-3,3,3-trifluoropropene (HFO-1233xf) and both cis- and trans-1-chloro-3,3,3-trifluoropropene (HFO-1233zd). The term HFO-1233zd is used herein generically to refer to 1-chloro-3,3,3-trifluoropropene, independent of whether it is the cis- or trans-form. The terms “cisHFO-1233zd” and “transHFO-1233zd” are used herein to describe the cis- and trans-forms of 1-chloro-3,3,3-trifluoropropene, respectively. The term “HFO-1233zd” therefore includes within its scope cisHFO-1233zd, transHFO-1233zd, and all combinations and mixtures of these.

Additional, compositions, uses, methods, embodiments and advantages to the present invention will be readily apparent to the skilled artisan on the basis of the disclosure provided.

### BRIEF DESCRIPTION OF THE DRAWINGS

FIG. 1 is a schematic representation of an ISF according to the present invention.

### DETAILED DESCRIPTION OF PREFERRED EMBODIMENTS

In general it is contemplated that the integral skin foams (sometimes referred to herein for convenience as “ISFs”) of the present invention can take a wide variety of forms, dimensions and physical configurations as required by the contemplated use and application. By way of non-limiting examples, the integral skin foams of the present invention can be in any one of the known categories of flexible ISF, semi-rigid ISF and rigid ISF and are useful in applications such as automotive and transportation applications, furniture and leisure, and other miscellaneous uses, and all such uses are within the scope of the present invention.

The present invention thus includes ISF as described herein, preferably flexible ISF, when present as a component or element of automotive steering wheels, automotive head rests, airbag deployment doors and covers, automotive handles, gear shift knobs, interior trim and armrests, bicycle seats, theater and stadium seating, motorcycle seats, pedestal encapsulation, dunnage, keyboard wrist rests, sport helmets, excise equipment, protective equipment, anti-fatigue mats, luggage racks, pleasure rides, roll bars, infant/baby seats and footware soles.

The present invention also includes ISF as described herein, preferably rigid or semi-rigid ISF, when present as a component or element of mirror surrounds, spoilers and wheel arch trim, other trim pieces or sunroof surrounds, wheel chocks, bumpers, equipment housings, chair arms and inserts, and filter press plates.

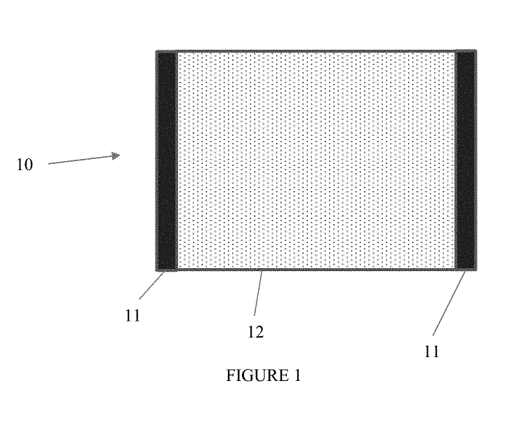

With respect to FIG. 1, a schematic representation of a integral skin foam 10 is shown in cross section having the typical construction of a relatively low density core section 11 integrally joined to relatively high density skin portion 10. In preferred embodiments, the skin has a density in the range of from about 45 pcf, preferably in a range of from about 45 pcf to about 75 pcf, with a density of about 60 pcf being preferred in some embodiments. The skin is preferably non-cellular or microcellular in structure. In contrast the core is generally cellular and preferably has an average density of from about 5 to less than about 45 pcf, and preferably an average density of less than about 20 pcf, more preferably less than about 18 pcf, and even more preferably less than about 15 pcf.

In typical embodiments, the skin has a thickness of from about 1 mm to about 5 mm.

### The Foamable Compositions

The foamable compositions of the present invention preferably comprise: (a) one or more polyols; (b) at least one isocyanate reactive with said polyols; (c) at least one blowing agent comprising, preferably in major proportion by weight, a physical blowing agent comprising: (i) one or more fluorochloropropenes and/or hexafluorobutenes, including preferably that the fluorochloropropene, when present, includes one or more trifluoro,monochloropropenes (HFO-1233) and (ii) optionally but preferably a chemical blowing agent, preferably water; (d) catalyst; (e) at least one chain extender; and (f) one or more surfactants.

The relative amounts of the components used in the foamable composition can vary widely according to the present invention, and all such relative amounts are within the broad scope of the invention. In preferred embodiments of the integral skin foams of the present invention, the following relative amount of the preferred component are preferred as indicated, with each value being understood as being preceded by the word about:

| RANGE, >>>> | | | |
|---|---|---|---|
| FOAMABLE COMPOSITION | | INTER- | |
| COMPONENT ▾▾▾ | BROAD | MEDIATE | NARROW |
| ISOCYANATE- Index | 80-120 | 90-110 | 95-105 |
| BLOWING AGENT | | | |
| CHEMICAL, php | 0-2 | 0-1 | 0-0.5 |
| PHYSICAL, php | 1-15 | 3-10 | 5-10 |
| CATALYST | | | |
| METAL, php | 0-1 | 0.001-1 | 0.005-0.2 |
| ORGANIC, php | 0.5-5 | 1-4 | 1-3 |

In preferred embodiments of the integral skin foams foe use as shoe soles of the present invention, the following relative amount of the preferred component are preferred as indicated, with each value being understood as being preceded by the word about:

| RANGE, >>>> | | | |
|---|---|---|---|
| FOAMABLE COMPOSITION | | | |
| COMPONENT | | INTER- | |
| ▾▾▾ | BROAD | MEDIATE | NARROW |
| ISCYONATE | | | |
| Index | 80-120 | 90-110 | 95-105 |
| NCO % | | | |
| BLOWING AGENT | | | |
| CHEMICAL, php | 0-2 | .5-1.5 | .5-1 |
| PHYSICAL, php | 0.5-10 | 1-8 | 1-5 |
| CATALYST | | | |
| METAL, php | 0-1 | 0.001-1 | 0.005-0.2 |
| ORGANIC, php | 0.5-5 | 1-4 | 1-3 |

A. Polyol

In general is it is contemplated that the type and a amount of polyol useful in accordance with the present invention can vary widely depending on the particular application or intended use of the integral skin foam to be produced. Thus, in its broadest sense, the polyol can include a single polyol or a mixture of polyols, provided the polyol or polyol mixture reacts in a known fashion with an isocyanate in preparing a polyurethane-based integral skin foam.

Thus, it is contemplated that the polyol can comprise any material that includes at least two hydroxyl groups in the molecule. In certain preferred emcodiments, the polyol may also include other functionalities in the molecule, including, ester, ether, amide, acrylic, metal, metalloid and other functionalities. In certain highly preferred embodiments, the polyol comprises a polyester polyol and/or a polyether polyol.

In preferred embodiments, the polyols of the present invention have a functionality of from about 2 to about 4, more preferably from about 2 to about 3, and even more preferably of about 3. As used herein, the term “functionality” for polyols refers to the average functionality calculated by dividing the total moles of OH dived by the total moles of polyol.

In preferred embodiments, the polyols of the present invention have an average molecular weight of from about 500 to about 4500.

In general, it is contemplated that the polyols of the present invention have a hydroxyl number of from about 20 to about 600. In preferred embodiments the hydroxyl number of the polyol will range from 20 to 150, more preferably from 20 to 100, more preferably from 20 to about 50.

As used herein, the term hydroxyl number refers to the value determined using a wet analytical as the value of milligrams of potassium hydroxide equivalent to the hydroxyl content in one gram of polyol. The equivalent weight of a polyol is the obtained by dividing the average molecular weight by the average functionality of the polyol.

A. Polyether Polyols

Polyether polyol may be those from the polymerization of a polyhydric alcohol and an alkylene oxide. Non-limiting examples of such alcohols include ethylene glycol (also know as mono-ethylene glycol or MEG), propylene glycol, trimethylene glycol, 1,2-butanediol, 1,3-butanediol, 1,4-butanediol, 1,2-pentanediol, 1,4-pentanediol, 1,5-pentanediol, 1,6-hexanediol, 1,7-heptanediol, glycerol, 1,1,1-trimethylolpropane, 1,1,1-trimethylolethane, or 1,2,6-hexanetriol. Any suitable alkylene oxide may be used such as ethylene oxide, propylene oxide, butylene oxide, amylene oxide, and mixtures of these oxides. The polyoxyalkylene polyether polyols may be prepared from other starting materials such as tetrahydrofuran and alkylene oxide-tetrahydrofuran mixtures, epihalohydrins such as epichlorohydrin, as well as aralkylene oxides such as styrene oxide. The polyoxyalkylene polyether polyols may have either primary or secondary hydroxyl groups. Included among the polyether polyols are polyoxyethylene glycol, polyoxypropylene glycol, polyoxybutylene glycol, polytetramethylene glycol, block copolymers, for example, combinations of polyoxypropylene and polyoxyethylene glycols, poly-1,2-oxybutylene and polyoxyethylene glycols and copolymer glycols prepared from blends or sequential addition of two or more alkylene oxides.

The polyol may have incorporated therein copolymer polyols of vinyl monomers in a continuous polyol phase, particularly dispersions of styrene/acrylonitrile (SAN) copolymers. Polyisocyanate polyaddition (PIPA) polyols (dispersions of polyurea-polyurethane particles in a polyol) and the polyurea dispersions in polyols (PHD polyols). Such polyols are described in Polyurethane Handbook, by G., Oertel, Hanser publishers, and U.S. Pat. Nos. 3,932,092; 4,014,846; 4,093,573 and 4,122,056, and EP Publications 0 418 039 B1 and EP 0 687 279 B1, all of which are incorporated herein by reference.

B. Polyester Polyols

In general polyester polyols (sometimes referred to herein as PEP for convenience) comprise a backbone that includes, and preferably consists essentially of ester and hydroxylic groups. In many preferred embodiments, the PEP may be formed by the reaction of one or more dicarboxylic acids with one or more diols.

The acid could be aliphatic and or aromatic. Non-limiting examples of aliphatic acids include those acids having the following general formula:

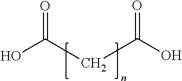

where n can be from 0 to about 10, more preferably from 0 to 5, with n=4 being preferred. Examples of such preferred dicarboxylic acids include oxalic acid, malonic acid, succinic acid, glutaric acid, adipic acid, pimelic acid, and suberic acid, with adipic acid being highly preferred in many embodiments.

In further embodiments, the acid could be an aromatic diacid such as phthalic acid or its isomers.

The non-limiting example of diols include aliphatic diols having the following general structure:

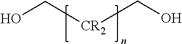

### Where:

each R is independently H or an alkyl group having from 1 to 4 carbon atoms and n is from 0 to [symbol] . In the case where both Rs are H, the diol is a straight chain diol; in cases where at least one R is an alkyl group, the diol is a branched diol.
Where n is from 0 to 10, more preferably 0 to 8. In preferred embodiments, the diol is a butanediol (n is 2).

Non-limiting examples of preferred diols include ethylene glycol, 1,3-propanediol, 1,4-butanediol, 1,5-pentanediol, 1,6-hexanediol, as well some branched diol such as 2-methyl-1,4-butanediol, 2-ethyl-1,4-butanediol,2,2-dimethyl-1,4-butanediol, 2,2-diethyl-1,4-butanediol, 3-methyl-1,5-pentanediol, 3-ethyl-1,5-pentanediol, 3,3-dimethyl-1,5-pentanediol, 3,3-diethyl-1,5-pentanediol, 3-methyl-3-ethyl-1,5-pentanediol, 3-methyl-1,6-hexanediol, 3-ethyl-1,6-hexanediol, 3,3-dimethyl-1,6-hexanediol, 3,3-diethyl-1,6-hexanediol, or the combination thereof.

The PEP preferred according to the present invention preferably have the general structure resulting from the condensation reaction between the selected diol and the selected dicarboxylic acid, or from the mixture of selected diols and selected dicarboxylic acids or mixtures of dicarboxylic acids. For example, in preferred embodiments of the present invention the PEP comprises a product formed from a reaction of 1,4-butanediol and adepic acid as follows:

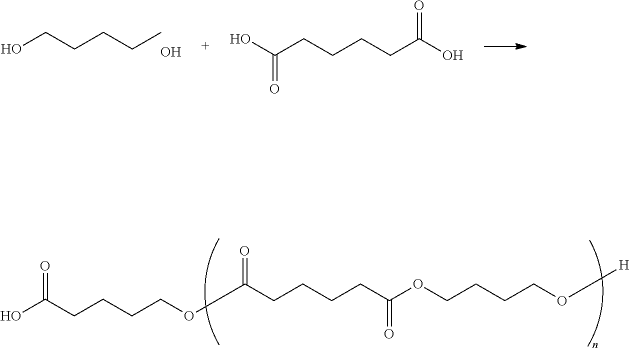

where n is controlled to obtain the desired degree of polymerization to achieve the target molecular weight.

In preferred embodiments, the polyol is the product of the condensation reaction of adipic acid and a mixture of diols, preferably a mixture of butanediol and ethylene glycol, to achieve a PEP product having an average molecular weight of from about 1500 to about 2500, preferably about 2000 and a hydroxyl number of from about 20 to about 40, more preferably from about 25 to about 35, and most preferably from about 25 to about 28.

Alternatively, PEP can be formed from starting material in which the hydroxyl group and the carboxylic acid (or their derivatives) may be within the same molecule. In such embodiments, the PEP can be formed by ring opening polymerization of cyclic esters, such as lactones, such as caprolactone, and cyclic carbonates The initiator of the ring opening reaction of caprolactone can include, for example, ethylene glycol, diethylene glycol, trimethyolpr opane, glycerine, pentaerythritol.

In preferred embodiments, the polyester polyols of the present invention have a functionality of from about 2 to about 4, more preferably from about 2 to about 3, and even more preferably of about 3.

In preferred embodiments, the polyester polyols polyols of the present invention have a molecular weight of from about 500 to about 4500.

In general, it is contemplated that the polyester polyols polyols of the present invention have a hydroxyl number of from about 20 to about 600. In preferred embodiments the hydroxyl number of the polyester polyols polyol will range from 20 to 150, more preferably from 20 to 100, more preferably from 20 to about 50.

The polyester polyols polyols preferably have a functionality range from 1.5 to 6, preferably from about 2 to about 4.

Preferred polyols include polyethylene glycols such as the commercially available materials sold under the trade designations Poly-L-255-28-1 and Poly G 85-29 by Monument Chemical Company and PLURACOL 5132 sold by BASF.

Another preferred polyol is a polyester polyol based on adapic acid and diethylene glycol (DEG) from COIM and sold under the trade designation Diexter 1100-56, having a hydroxyl number of 56.

Another preferred polyol is a polyester polyol based on adapic acid reacted with ethylene glycol and butanediol from COIM sold under the trade designation Diexter-G 2470-56U, having a hydroxyl number of 56.

Another preferred polyol is a polyester polyol based on adapic acid reacted with ethylene glycol (MEG) and diethylene glycol (DEG) from KAIROS System House sold under the trade designation HDR V4, having a hydroxyl number of 56. Similar polyol based on adapic acid reacted with ethylene glycol (MEG) and diethylene glycol (DEG) is available from COIM as Diexter-G 2150.

Another preferred polyol is a trifunctional polyether polyol tipped with ethylene oxide from REPSOL sold under the trade designation Alcupol C 2831. Similar trifunctional polyether polyol tipped with ethylene oxide are available under the trade desigantions Pluracol 2090, Pluracol 1026 from BASF, or Multranol 3901 from Bayer.

In embodiments involving shoe sole applications, it preferable that the polyol comprises, and preferably in an amount of from about 10 to about 70% on a weight basis of the polyol, more preferably of from about 30 to about 70% on a weight basis of the polyol, a SAN grafted polyether polyol and/or a SAN grafter polyester polyol, preferably having a solids content of from about 5% to about 40%, more preferably from about 10 to about 35%, more preferably in certain embodiment from about 10 to about 20% by weight. Preferred SAN grafted polyether polyols include the polyol sold under the trade designation Alcupol P3021 from REPSOL. Similar SAN grafted polyether polyols are available under the trade desigantions Pluracol 4815 by BASF. Preferred SAN grafted polyester polyols include the polyol sold under the trade PE016 by KIMPol. Similar SAN grafted polyester polyols include the materials sold as designations Hoopol PM-245, Hoopol PM-445, Hoopol PM-2245 from Synthesia.

The properties of some of the preferred polyols of the present invention are provided in the following table:

| Property>>> | | | OH | Acid | | | |
|---|---|---|---|---|---|---|---|
| Polyol | Molecular | | Number | Number | | Viscosity | |
| ▾ | Weight | Func- | (Avg.) | Max. | pH | @ 25° C. | Other |
| ▾ | (Avg.) | tionality | (mg KOH/g) | (mg KOH/g) | Avg | (cp) | Information |
| Polyol 91610 | | | 56 | | | | |
| Poly-L-255-28 | 4000 | 2 | 28 | .02 | 6 | 1000 | |
| Poly-G-85-29 | 6000 | 3 | 28 | .05 | 7.4 | 1150 | |
| Pluracol 5132 | 6700 | 3 | 25 | | 7 | 3320 | |
| Diexter-G | 2000 | | 56 | | | | a polyester |
| 2470-56U | | | | | | | polyol of adipic |
| | | | | | | | acid with |
| | | | | | | | ethylene glycol |
| | | | | | | | and butanediol |
| | | | | | | | from COIM. |
| Diexter-1100- | | | 56 | | | | a polyester |
| 56 | | | | | | | polyol based on |
| | | | | | | | adapic acid and |
| | | | | | | | DEG from |
| | | | | | | | COIM |
| Alcupol C | 6000 | | 28 | | | | trifunctional |
| 2831 | | | | | | | polyether |
| | | | | | | | polyol tipped |
| | | | | | | | with ethylene |
| | | | | | | | oxide. Fro, |
| | | | | | | | Repsol |
| Alcupol | 5600 | | 30 | | | | acrylonitrile- |
| P3021 | | | | | | | styrene grafted |
| | | | | | | | trifunctional |
| | | | | | | | polyol from |
| | | | | | | | REPSOL (Solid |
| | | | | | | | content: 15%) |
| HDR V4 | 2000 | | 56 | | | 2500+-250 | polyester polyol |
| | | | | | | at 40 C. | (PES) based |
| | | | | | | (ASTM | adipic |
| | | | | | | D 445) | acid/MEG/DEG |
| | | | | | | | with a hydroxyl |
| | | | | | | | number of 56 |
| | | | | | | | from Kairos |
| PE016 | | | 57-63 | | | 1500-3500 | SAN-grafted |
| | | | | | | (mPa · s | polyester polyol |
| | | | | | | at 60 C.) | with a hydroxyl |
| | | | | | | | number of 60 |
| | | | | | | | from Kimteks |

In certain preferred embodiments a combination of polyols is used in the formulation, and in highly preferred embodiments the polyol comprises a combination of Poly-I-255-28-1;Poly-G-85-29; Pluracol 5132 in relative proportions, by weight of from about 50-70:10-30;10-30, with a relative proportion of about 60:20:20 being preferred.

B. Isocayanate

A foamable composition suitable for forming a polyurethane or polyisocyanurate foam may be formed by reacting an organic polyisocyanate and the polyol premix composition described above. Any organic polyisocyanate can be employed in polyurethane or polyisocyanurate foam synthesis inclusive of aliphatic and aromatic polyisocyanates. Suitable organic polyisocyanates include aliphatic, cycloaliphatic, araliphatic, aromatic, and heterocyclic isocyanates which are well known in the field of polyurethane chemistry. These are described in, for example, U.S. Pat. Nos. 4,868,224; 3,401,190; 3,454,606; 3,277,138; 3,492,330; 3,001,973; 3,394,164; 3,124.605; and 3,201,372, each of which is incorporated herein by reference.

Representative organic polyisocyanates correspond to the formula:

R(NCO)z

wherein R is a polyvalent organic radical which is either aliphatic, aralkyl, aromatic or mixtures thereof, and z is an integer which corresponds to the valence of R and is at least two. Representative of the organic polyisocyanates contemplated herein includes, for example, the aromatic diisocyanates such as 2,4-toluene diisocyanate, 2,6-toluene diisocyanate, mixtures of 2,4- and 2,6-toluene diisocyanate, crude toluene diisocyanate, methylene diphenyl diisocyanate, crude methylene diphenyl diisocyanate and the like; the aromatic triisocyanates such as 4,4′,4″-triphenylmethane triisocyanate, 2,4,6-toluene triisocyanates; the aromatic tetraisocyanates such as 4,4′-dimethyldiphenylmethane-2,2′5,5′-tetraisocyanate, and the like; arylalkyl polyisocyanates such as xylylene diisocyanate; aliphatic polyisocyanate such as hexamethylene-1,6-diisocyanate, lysine diisocyanate methylester and the like; and mixtures thereof. Other organic polyisocyanates include polymethylene polyphenylisocyanate, hydrogenated methylene diphenylisocyanate, m-phenylene diisocyanate, naphthylene-1,5-diisocyanate, 1-methoxyphenylene-2,4-diisocyanate, 4,4′-biphenylene diisocyanate, 3,3′-dimethoxy-4,4′-biphenyl diisocyanate, 3,3′-dimethyl-4,4′-biphenyl diisocyanate, and 3,3′-dimethyldiphenylmethane-4,4′-diisocyanate. Typical aliphatic polyisocyanates are alkylene diisocyanates such as trimethylene diisocyanate, tetramethylene diisocyanate, and hexamethylene diisocyanate, isophorene diisocyanate, 4,4′-methylenebis(cyclohexyl isocyanate), and the like. Typical aromatic polyisocyanates include m- and p-phenylene disocyanate, polymethylene polyphenyl isocyanate, 2,4- and 2,6-toluenediisocyanate, dianisidine diisocyanate, bitoylene isocyanate, naphthylene 1,4-diisocyanate, bis(4-isocyanatophenyl)methene, bis(2-methyl-4-isocyanatophenyl)methane, and the like.

Quasi-prepolymers may also be employed in the process of the subject invention. These quasi-prepolymers are prepared by reacting an excess of organic polyisocyanate or mixtures thereof with a minor amount of an active hydrogen-containing compound determined by the well-known Zerewitinoff Test, as described by Kohler in Journal of the American Chemical Society, 49, 3181 (1927). The non-limiting examples active hydrogen-containing compounds include the aforementioned poly ether polyols, polyester polyols or the combination thereof.

These polyisocyanates are prepared by conventional methods known in the art. In the present invention, the polyisocyanate and the polyol are employed in amounts which will yield an NCO/OH stoichiometric ratio in a range of from about 0.8 to about 2.0. In the present invention, the NCO/OH equivalent ratio is, preferably, about 0.9 or more and about 2.0 or less, with the ideal range being from about 0.95 to about 1.2.

In preferred embodiments of the integral skin foam of the present invention, the isocyanate comprises, preferably comprises at least about 50% by weight, more more preferably consists essentially of, MDI (including 2,2′-MDI, 2,4′-MDI, and 4,4′-MDI), or an isocyante based on MDI. As the term is used herein, 4,4′-MDI refers to compounds having the structure

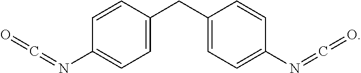 [SMILES: O=C=Nc1ccc(Cc2ccc(N=C=O)cc2)cc1]

A preferred MDI-based isocyanate is a uretonamine-modified isocyantate available commercially under the trade designation Rubinate 1209 from Huntsman and has the following properties: % NCO—21.5%; Functionality—2.12; Specific Gravity—1.16; Equivalent Weight—195; Viscosity—390 centipoise at 25° C. A preferred MDI-based isocyanate is a polyester based isocyanate prepolymer available commercially under the trade designation Rubinate 1234 from Huntsman and has the following properties: % NCO—18.9% and a Functionality of 2.01

A preferred MDI-based isocyanate is a polyether based isocyanate prepolymer available commercially under the trade designation ISN 42 from KAIROS and has the following properties: % NCO—20.5 +/−0.5%, a Functionality of 3 and a viscosity in mPas of 250+/−50 at 25° C. (ASTM D 445).

A preferred MDI-based isocyanate is a polyester based isocyanate prepolymer available commercially under the trade designation ISN 26 from KAIROS and has the following properties: % NCO—18.06 +/−0.5%, a Functionality of 3, and a viscosity in mPas of 370+/−50 at 40° C. (ASTM D 445).

C. Blowing Agent Composition

It is contemplated that in certain embodiments of the present invention the blowing agent compositions consist essentially of or consist of trifluoro,monochloropropenes, particularly the preferred transHFO-1233zd as described above. Thus, the present invention includes methods and systems which include using each of these compounds, alone or in combination, as a blowing agent, particularly in integral skin foam applications, without the presence of any substantial amount of additional components. However, one or more co-blowing agents or components are optionally, but in certain embodiments preferably, included in the blowing agent compositions of the present invention.

The co-blowing agent in accordance with the present invention can comprise a physical blowing agent, a chemical blowing agent (which preferably in certain embodiments comprises water) or a blowing agent having a combination of physical and chemical blowing agent properties. It will also be appreciated that the blowing agents included in the present compositions may exhibit properties in addition to those required to be characterized as a blowing agent. For example, it is contemplated that the blowing agent compositions of the present invention may include components which also impart some beneficial property to the blowing agent composition or to the integral skin foamable composition to which it is added. For example, it is within the scope of the present invention for the blowing agent to also act as a polymer modifier or as a viscosity reduction modifier.

In certain preferred embodiments, the present invention provides blowing agent compositions, integral skin foamable compositions, integral skin foams and/or foamed articles (including shoe soles) comprising one or more C2 to C6 fluorinated alkenes, and more preferably C3 to C4 fluorinated alkenes, including any one or more of the preferred groups and/or preferred individual fluorinated alkene compounds mentioned herein, and one or more additional compounds selected from the group consisting of hydrocarbons, hydrofluorocarbons (HFCs), ethers, esters, acetals, alcohols, aldehydes, ketones, methyl formate, formic acid, water, trans-1,2-dichloroethylene, carbon dioxide and combinations of any two or more of these. Among ethers, it is preferred in certain embodiments to use ethers having from one to six carbon atoms. Among alcohols, it is preferred in certain embodiments to use alcohols having from one to four carbon atoms. Among aldehydes, it is preferred in certain embodiments to use aldehydes having from one to four carbon atoms. Among ketones, it is preferred in certain embodiments to use ketones, having from one to four carbon atoms.

1. Other Haloalkene Blowing Agents

Preferred co-blowing agents include one or more compounds other haloalkenes, including but not limited to those other compounds in accordance with Formula II below:

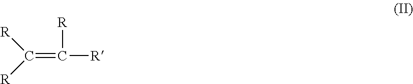

where each R is independently (CR₂)ₙY, Cl, F, Br, I or H

R′ is (CR₂)ₙY,

Y is CRF₂

and n is 0, 1, 2 or 3, preferably 0 or 1, it being generally preferred however that either Br is not present in the compound or when Br is present in the compound there is no hydrogen in the compound.

In certain highly preferred embodiments, each R is independently Cl, F, Br, I or H, Y is CF₃, n is 0 or 1 (most preferably 0) and at least one of the remaining Rs is F, and preferably no R is Br, or when Br is present there is no hydrogen in the compound. It is preferred in certain cases that no R in Formula II is Br.

In certain preferred embodiments, the compound of the present invention comprises a C3 or C4 HFO, preferably a C3 HFO, and more preferably a compound in accordance with Formula II in which Y is CF₃, n is 0, at least one R on the unsaturated terminal carbon is H, and at least one of the remaining Rs is Cl. HFO-1233 is an example of such a preferred compound.

In highly preferred embodiments, especially embodiments which comprise the low toxicity compounds described above, n is zero. In certain highly preferred embodiments the compositions of the present invention comprise one or more tetrafluoropropenes, including HFO-1234yf, (cis)HFO-1234ze and (trans)HFO-1234ze, with HFO-1234ze being generally preferred and trans HFO-1234ze being highly preferred in certain embodiments. Although the properties of (cis)HFO-1234ze and (trans)HFO-1234ze differ in at least some respects, it is contemplated that each of these compounds is adaptable for use, either alone or together with other compounds including its stereo isomer, in connection with each of the applications, methods and systems described herein. For example, (trans)HFO-1234ze may be preferred for use in certain systems because of its relatively low boiling point (−19° C.), while (cis)HFO-1234ze, with a boiling point of +9° C., may be preferred in other applications. Of course, it is likely that combinations of the cis- and trans-isomers will be acceptable and/or preferred in many embodiments. Accordingly, it is to be understood that the terms “HFO-1234ze” and 1,3,3,3-tetrafluoropropene refer to both stereo isomers, and the use of this term is intended to indicate that each of the cis-and trans-forms applies and/or is useful for the stated purpose unless otherwise indicated.

HFO-1234 compounds are known materials and are listed in Chemical Abstracts databases. The production of fluoropropenes such as CF₃CH⊚CH₂ by catalytic vapor phase fluorination of various saturated and unsaturated halogen-containing C₃ compounds is described in U.S. Pat. Nos. 2,889,379; 4,798,818 and 4,465,786, each of which is incorporated herein by reference. EP 974,571, also incorporated herein by reference, discloses the preparation of 1,1,1,3-tetrafluoropropene by contacting 1,1,1,3,3-pentafluoropropane (HFC-245fa) in the vapor phase with a chromium-based catalyst at elevated temperature, or in the liquid phase with an alcoholic solution of KOH, NaOH, Ca(OH)₂ or Mg(OH)₂. In addition, methods for producing compounds in accordance with the present invention are described generally in connection with pending United States Patent Application entitled “Process for Producing Fluorpropenes” bearing U.S. application Ser. No. 10/694,272 (now U.S. Pat. No. 7,230,146), which is also incorporated herein by reference.

Other preferred compounds for use in accordance with certain aspects of the co-bowing agents of the present invention include pentafluoropropenes, including all isomers thereof (eg., HFO-1225), tetra- and penta-fluorobutenes, including all isomers thereof (eg., HFO-1354 and HFO-1345). Even further preferred compounds for use in accordance with the present invention include hexafluorobutenes, including all isomers of HFO-1336, particularly 1,1,1,4,4,4-hexafluoropropene. The present compositions may also comprise combinations of any two or more compounds within the broad scope of the invention or within any preferred scope of the invention.

The present compositions, particularly those comprising HFO-1234 (including HFO-1234ze and HFO-1234yf), HFO-1233zd (including HFO-1233zd), and HFO-1336 (including HFO-1336mzzm), are believed to possess properties that are advantageous for a number of important reasons. For example, applicants believe that the fluoroolefins of the present invention will not have a substantial negative affect on atmospheric chemistry, being negligible contributors to ozone depletion in comparison to some other halogenated species. The preferred compositions of the present invention thus have the advantage of not contributing substantially to ozone depletion. The preferred compositions also do not contribute substantially to global warming compared to many of the hydrofluoroalkanes presently in use.

In certain preferred forms, compositions of the present invention have a Global Warming Potential (GWP) of not greater than about 1000, more preferably not greater than about 500, and even more preferably not greater than about 150. In certain embodiments, the GWP of the present compositions is not greater than about 100 and even more preferably not greater than about 75. As used herein, “GWP” is measured relative to that of carbon dioxide and over a 100 year time horizon, as defined in “The Scientific Assessment of Ozone Depletion, 2002, a report of the World Meteorological Association's Global Ozone Research and Monitoring Project,” which is incorporated herein by reference.

In certain preferred forms, the present compositions also preferably have an Ozone Depletion Potential (ODP) of not greater than 0.05, more preferably not greater than 0.02 and even more preferably about zero. As used herein, “ODP” is as defined in “The Scientific Assessment of Ozone Depletion, 2002, A report of the World Meteorological Association's Global Ozone Research and Monitoring Project,” which is incorporated herein by reference.

2. Ethers

In certain preferred embodiments, present compositions include at least one ether, which may function as a co-blowing agent in the composition. The ethers in certain non-limiting aspects may be represented by the following formula IIIA:

CₐR_{b}—O—C_{d}Rₑ (IIIA)

wherein each “R” is a hydrogen, halogen, or C₁-C₂₀ unsaturated, substituted or unsubstituted radical. In certain non-limiting embodiments, each R is independently H, Cl, F, Br, I, a C₁ to C₈ alkyl group, a C₁ to C₈ alkenyl group, a C₁ to C₈ alcohol group, a C₁ to C₈ ether group, a C₅ to C₇ cyclic alkyl group, a C₅ to C₇ cyclic alkenyl group, a C₅ to C₇ heterocyclic alkyl group, and/or a C₅ to C₇ heterocyclic alkenyl group. Any of the foregoing, where applicable, may be optionally substituted. In certain non-limiting embodiments, the ether comprises at least one of dimethylether, methylethylether, diethylether, methylpropylether, methylisopropylether, ethylpropylether, ethylisopropylether, dipropylether, dipropylether, or diisopropylether.

In certain embodiments, the ether(s) used in accordance with this aspect of the invention comprise fluorinated ethers (FEs), more preferably one or more hydro-fluorinated ethers (HFEs)), and even more preferably one or more C3 to C5 hydro-fluorinated ethers in accordance with Formula (III) below:

CₐH_{b}F_{c}—O—C_{d}HₑF_{f} (IIIB)

where

a=1-6, more preferably 2-5, and even more preferably 3-5,

b=1-12, more preferably 1-6, and even more preferably 3-6,

c=1-12, more preferably 1-6, and even more preferably 2-6,

d=1-2

e=0-5, more preferably 1-3

f=0-5, more preferably 0-2,

and where one of said Cₐ may be bound to one of said C_{d} to form a cyclofluoroether.

Certain preferred embodiments of the present invention are directed to compositions comprising at least one fluoroalkene as described herein and at least one fluoro-ether, more preferably at least one hydro-fluoroether, containing from 2 to 8, preferably 2 to 7, and even more preferably 2 to 6 carbon atoms, and in certain embodiments most preferably three carbon atoms. The hydro-fluoroether compounds of the present invention are sometimes referred to herein for the purpose of convenience as hydrofluoro-ethers or “HFEs” if they contain at least one hydrogen.

Applicants believe that, in general, the fluoroethers in accordance with the present disclosure and in particular in accordance with above identified Formula (III) are generally effective and exhibit utility in combination with the fluoroalkene compounds in accordance with the teachings contained herein. However, applicants have found that from among the fluroethers, it is preferred to use in certain embodiments, especially embodiments relating to blowing agent compositions and foam and foaming methods, to utilize hydrofluorethers that are at least difluorinated, more preferbably at least trifluorinated, and even more preferably at least tetra-fluorinated. Especially preferred in certain embodiments are tetrafluorinated fluorethers having from 3 to 5 carbon atoms, more preferably 3 to 4 carbon atoms, and even more preferably 3 carbon atoms.

In certain preferred embodiments, the compound of the present invention comprises a 1,1,2,2-tetrafluoroethylmethylether (which is sometimes referred to herein as HFE-245pc or HFE-245cb2), including any and all isomeric forms thereof.

3. The Acetals

In certain preferred embodiments, present compositions include at least one acetal, which may function as a co-blowing agent in the composition. The acetals in certain non-limiting aspects may be represented by the following formula: R₂C(OR′)₂. Each “R” is independently a hydrogen, or C₁-C₂₀ unsaturated, substituted or unsubstituted radical. In certain non-limiting embodiments, each R is independently H, Cl, F, Br, I, a C₁ to C₈ alkyl group, a C₁ to C₈ alkenyl group, a C₁ to C₈ alcohol group, a C₁ to C₈ ether group, a C₅ to C₇ cyclic alkyl group, a C₅ to C₇ cyclic alkenyl group, a C₅ to C₇ heterocyclic alkyl group, and/or a C₅ to C₇ heterocyclic alkenyl group. Any of the foregoing, where applicable, may be optionally substituted. In certain non-limiting embodiments the acetal is at least partially symmetrical in that both R′ groups are the same and/or both R groups are the same. In further embodiments, the acetal is fully symmetrical wheren both R′ groupls are the same and both R groups are the same. In certain non-limiting embodiments, the acetal is at least one of methylal, dimethyloxymethane, diethoxymethane, dipropyloxymethane, or dibutoxymethane.

4. The Hydrofluorocarbons

In certain embodiments it is preferred that the blowing agent compositions of the present invention include one or more HFCs as co-blowing agents, in certain embodiments more preferably one or more C1-04 HFCs. By way of non-limiting example, the present blowing agent compositions may include one or more of difluoromethane (HFC-32), fluoroethane (HFC-161), difluoroethane (HFC-152), trifluoroethane (HFC-143), tetrafluoroethane (HFC-134), pentafluoroethane (HFC-125), pentafluoropropane (HFC-245), hexafluoropropane (HFC-236), heptafluoropropane (HFC-227ea), pentafluorobutane (HFC-365), hexafluorobutane (HFC-356) and all isomers of all such HFC's.

In certain embodiments, one or more of the following HFC isomers are preferred for use as co-blowing agents in the compositions of the present invention:

fluoroethane (HFC-161)

1,1,1,2,2-pentafluoroethane (HFC-125)

1,1,2,2-tetrafluoroethane (HFC-134)

1,1,1,2-tetrafluoroethane (HFC-134a)

1,1,1-trifluoroethane (HFC-143a)

1,1-difluoroethane (HFC-152a)

1,1,1,2,3,3,3-heptafluoropropane (HFC-227ea)

1,1,1,3,3,3-hexafluoropropane (HFC-236fa)

1,1,1,2,3,3-hexafluoropropane (HFC-236ea)

1,1,1,2,3-pentafluoropropane (HFC-245eb)

1,1,2,2,3-pentafluoropropane (HFC-245ca)

1,1,1,3,3-pentafluoropropane (HFC-245fa)

1,1,1,3,3-pentafluorobutane (HFC-365mfc) and

1,1,1,2,2,3,4,5,5,5-decafluoropentane (HFC-43-10-mee).

5. The Hydrocarbons

In certain embodiments it is preferred that the blowing agent compositions of the present invention include one or more hydrocarbons, in certain embodiments more preferably C3-C6 hydrocarbons. The present blowing agent compositions may include in certain preferred embodiments, for example: propane; iso- and normal-butane; iso-, normal-, neo- and/or cyclo-pentane (each of such pentanes being preferable for use as a blowing agent for thermoset foams); iso- and normal-hexane; and heptanes.

6. The Alcohols

In certain embodiments it is preferred that the blowing agent compositions of the present invention include one or more alcohols, in certain embodiments preferably one or more C1-C4 alcohols. For example, the present blowing agent compositions may include one or more of methanol, ethanol, propanol, isopropanol, butanol, iosbutanol, t-butanol.

7. The Aldehydes

In certain embodiments it is preferred that the blowing agent compositions of the present invention include one or more aldehydes, particularly Cl-C4 aldehydes, including formaldehyde, acetaldehyde, propanal, butanal and isobutanal.

8. The Ketones

In certain embodiments it is preferred that the blowing agent compositions of the present invention include one or more ketones, preferably Cl-C4 ketones. For example, the present blowing agent compositions may include one or more of acetone, methylethylketone, and methylisobutylketone.

9. The Esters

In certain embodiments it is preferred that the blowing agent compositions of the present invention include one or more esters. The esters in certain non-limiting aspects may be represented by the following formula: RCO(OR′). Each “R” and “R′” is independently a hydrogen, or C₁-C₂₀ unsaturated, substituted or unsubstituted radical. In certain non-limiting embodiments, each R and R′ is independently H, Cl, F, Br, I, a C₁ to C₈ alkyl group, a C₁ to C₈ alkenyl group, a C₁ to C₈ alcohol group, a C₁ to C₈ ether group, a C₅ to C₇ cyclic alkyl group, a C₅ to C₇ cyclic alkenyl group, a C₅ to C₇ heterocyclic alkyl group, and/or a C₅ to C₇ heterocyclic alkenyl group. Any of the foregoing, where applicable, may be optionally substituted. In certain non-limiting embodiments each R and R′ is an optionally substituted alkyl group having between 1 and 8 carbon atoms, in certain embodiments between 1 and 4 carbon atoms. Non-limiting examples of esters that may be used as co-blowing agents in conjunction with the present invention include methyl formate, ethyl formate, propyl formate, methyl acetate, ethyl acetate, methyl propionate, ethyl propionate.

The relative amount of any of the above noted additional, compounds, which are contemplated for use in certain embodiments as co-blowing agents, as well as any additional components which may be included in present compositions, can vary widely within the general broad scope of the present invention according to the particular application for the composition, and all such relative amounts are considered to be within the scope hereof. Applicants note, however, that one particular advantage of at least certain of the compounds of Formula I in accordance with the present invention, for example HFO-1234ze or HFO-1233 or HFO-1336, is the relatively low flammability of such compounds. Accordingly, in certain embodiments it is preferred that the blowing agent composition of the present invention comprise at least one co-blowing agent and an amount of compound(s) in accordance with Formula I sufficient to produce a blowing agent composition which is overall nonflammable. Thus, in such embodiments, the relative amounts of the co-blowing agent in comparison to the compound of Formula I will depend, at least in part, upon the flammability of the co-blowing agent.

The blowing agent compositions of the present invention may include the compounds of the present invention in widely ranging amounts. It is generally preferred, however, that for preferred compositions for use as blowing agents in accordance with the present invention, compound(s) in accordance with Formula I, and even more preferably Formula II, are present in an amount that is at least about 1% by weight, more preferably at least about 5% by weight, and even more preferably at least about 15% by weight, of the composition. In certain preferred embodiments, the blowing agent comprises at least about 50% by weight of the present blowing agent compound(s), and in certain embodiments the blowing agent consists essentially of compounds in accordance with the present invention. In this regard it is noted that the use of one or more co-blowing agents is consistent with the novel and basic features of the present invention. For example, it is contemplated that water will be used as either a co-blowing or in combination with other co-blowing agents (such as, for example, pentane, particularly cyclopentane) in a large number of embodiments.

It is contemplated that the blowing agent compositions of the present invention may comprise, preferably in amounts of at least about 15% by weight of the composition, HFO-1234yf, cisHFO-1234ze, transHFO1234ze, cisHFO-1233zd, transHFO-1233zd, cisHFO-1336mzzm, transHFO-1336mzzm, or combinations of two or more of these. In many preferred embodiments, a co-blowing agent comprising water is included in the compositions, most preferably in compositions directed to the use of the formation of integral skin foams. In certain preferred embodiments, when the blowing agent compositions of the present invention include a combination of cisHFO-1234ze and transHFO1234ze, the compounds may be provided in a cis:trans weight ratio of from about 1:99 to about 50:50, more preferably from about 10:90 to about 30:70. In certain embodiments, it may be preferred to use a combination of cisHFO-1234ze and transHFO1234ze in a cis:trans weight ratio of from about 1:99 to about 10:90, and preferably from about 1:99 to about 5:95. Of course, it may be desirable in certain embodiments to use combinations in which the cis-isomer is present in a higher concentration than the trans-isomer, as may be the case, for example, for use with foamable compositions adapted for use with liquid blowing agents. In certain preferred embodiments, transHFO-1234ze, transHFO-1233zd, or cisHFO-1336mzzm are the preferred isomers, though such isomers may be provided with certain amounts of the opposing isomer (e.g. cisHFO-1234ze, cisHFO-1233zd, or transHFO-1336mzzm), including residual amounts of such opposing isomers (e.g. at or below about 10%, 5%, 2%, 1%, 0.5%, or the like)

In certain preferred embodiments, the blowing agent composition comprises from about 30% to about 95% by weight, more preferably from about 30% to about 96%, more preferably from about 30% to about 97%, and even more preferably from about 30% to about 98% by weight, and even more preferably from about 30% to about 99% by weight of a compound of Formula I, more preferably a compound of Formula II, and even more preferably one or more HFO-1234, HFO-1233, and/or HFO-1336 compounds, and from about 5% to about 90% by weight, more preferably from about 5% to about 65% by weight of co-blowing agent, including one or more fluoroethers. In certain of such embodiments the co-blowing agent comprises, and preferably consists essentially of a compound selected from the group consisting of, H₂O, HFCs, HFEs, hydrocarbons, alcohols (preferably C2, C3 and/or C4 alcohols), CO₂, ethers, esters, acetals, ketones, aldehydes, and combinations of any two or more of these.

D. Catalysts

Applicants to the presently described invention have discovered that certain of the presently described blowing agents and/or co-blowing agentsare detrimentally reactive with certain amine catalysts used in conjunction with foam formation. Although applicants do not intend to be bound by or to any particular theory of operation, it is believed that the deleterious effects observed by applicants may occur as a result of the reaction between hydrohaloolefins included in the blowing agent, including particularly HFCO-1233zd(E) and certain of the amine catalysts. It is believed that this reaction produces a halogen ion, such as a fluorine ion or chlorine ion, which leads to a decrease in the reactivity of the blowing agent. In addition, applicants believe that the deleterious effects may also be caused, either alone or in addition to the above causes, by the halogen ion, such as fluoride, produced from the above noted reaction in turn reacting with surfactant, particularly silicone surfactant, present in such blowing agents and related systems to produce a lower average molecular weight surfactant, which is then a less effective than originally intended. This depletion/degradation of the surfactant is believed to reduce the integrity of the cell wall and produce a foam that exhibits higher than desired levels of cell collapse. Accordingly, the selection of certain ingredients, particularly the catalysts and optionally the surfactant, or the placement of such components in the foam premix (whether together or separate) may be varied in accordance with the present invention so as to minimize or eliminate entirely such degradation and result in a storage stable premix composition.

As used herein, in certain aspects, the term “storage stability,” at least as it relates to the stability of the foam premixes of the present invention, means that the foam exhibits little to no deleterious degradative effects after aging. In certain embodiments, aging may be measured by exposing the premix (containing at least a hydrohaloolefin blowing agent, a catalyst provided herein, and optionally a surfactant provided herein) to a temperature between about 120° F. and about 130° F. for at least 48 hours, at least 62 hours, or at least 72 hours. Examples of degradative effects may be poor appearance in the foam premix, such as yellowing, and/or poor appearance in the resulting foam, post-aging, including evidence of cell collapse. Degradative effects may also, or alternatively, be measured by fluoride ion content, where the less fluoride ion that is present is indicative of less degradation.

The catalyst (or catalyst systems) used in conjunction with the foams and foamable compositions of the present invention may include amine catalysts, non-amine catalysts or a combination of both. As noted above, applicants have found with the former that certain amine catalysts do not exhibit such degradative reactivity. To this end, in certain embodiments, the amine catalyst includes any compound containing an amino group and exhibiting the catalytic activity provided herein, but preferably not exhibiting degradative reactivity with the hydrohaloolefin blowing agent. Such compounds may be straight chain or branched chain, cyclic non-aromatic or aromatic in nature.

In certain aspects, the amine catalyst is a sterically hindered amine. Such sterically hindered amine catalysts, in certain aspects, has the formula R₁R₂N-[A-NR₃]ₙR₄ wherein each of R₁, R₂, R₃, and R₄ is independently H, a C₁ to C₈ alkyl group, a C₁ to C₈ alkenyl group, a C₁ to C₈ alcohol group, or a C₁ to C₈ ether group, or R₁ and R₂ together form a C₅ to C₇ cyclic alkyl group, a C₅ to C₇ cyclic alkenyl group, a C₅ to C₇ heterocyclic alkyl group, or a C₅ to C₇ heterocyclic alkenyl group; A is a C₁ to C₈ alkyl group, a C₁ to C₅ alkenyl group, or an ether; n is 0, 1, 2, or 3. In certain non-limiting aspects, the sterically hindered amine contains only one methyl group as a substituent group.

Useful sterically hindered amines include a sterically hindered primary amine, secondary amine or tertiary amine. In certain non-limiting embodiments, the amines do not contain more than one methyl group per each nitrogen. Useful sterically hindered tertiary amine catalysts non-exclusively include dicyclohexylmethylamine; ethyldlisopropylamine; dimethylcyclohexylamine; dimethylisopropylamine; methylisopropylbenzylamine; methylcyclopentylbenzylamine; N, N-dimethylethanolamine, dimethylaminoethoxyethanol, N,N,N′-trimethylaminoethyl-ethanolamine, 2-[[2-[2-(dimethylamino)ethoxy]ethyl] methylamino] ethanol, N,N-dimethylisopropylamine; N-methyl-N-siopropylbenzylamine; N-methyl-N-cyclopentylbenzylamine; isopropyl-sec-butyl-trifluoroethylamine; diethyl-(α-phenylethyl)amine, tri-n-propylamine, or combinations thereof.

Other useful sterically hindered amines includes morpholines, imidazoles, ether containing compounds, and the like. These include
dimorpholinodiethylether
N-ethyl morpholine
N-methylmorpholine
bis(dimethylaminoethyl)ether
imidizole
n-methylimidazole
1,2-dimethylimidazole
Hydroxymethylimidazole
Hydroxyethylimidazole
Hydroxypropylimidazole
Butylhydroxymethylimidazole
Dimorpholinodimethylether
Dimethylaminoethoxyethanol
benzyldimethylamine
N,N,N′,N′,N″,N″-pentamethyldiethylenetriamine
N,N,N′,N′,N″,N″-pentaethyldiethylenetriamine
N,N,N′,N′,N″,N″-pentamethy d propylenetriamine
bis(diethylaminoethyl)ether
bis(dimethylaminopropyl)ether

The sterically hindered amine catalyst may be present in the polyol premix composition in an amount of from about 0.1 wt. % to about 10 wt. %, preferably from about 0.1 wt. % to about 8.0 wt. %, preferably from about 0.2 wt. % to about 6.5 wt. %, more preferably from about 0.3 wt. % to about 6.0 wt. %, and more preferably from about 0.3 wt. % to about 5.0 wt. %, by weight of the polyol premix composition. Such amounts are non-limiting to the present invention. To this end, the quantity of the foregoing catalysts can vary widely, and the appropriate or effective amount can be easily be determined by those skilled in the art.

In further embodiments, the amine catalyst is an adduct of an amine catalyst and an organic acid. In one embodiment, the amine has the formula R₁iR₂N-[A-NR₃]ₙR₄ wherein each of R₁, R₂, R₃, and R₄ is independently H, a C₁ to C₈ alkyl group, a C₁ to C₈ alkenyl group, C₁ to C₈ alcohol group, or a C₁ to C₈ ether group, or R₁ and R₂ together form a C₅ to C₇ cyclic alkyl group, a C₅ to C₇ cyclic alkenyl group, a C₅ to C₇ heterocyclic alkyl group, or a C₅ to C₇ heterocyclic alkenyl group; A is a C₁ to C₅ alkyl group, a C₁ to C₅ alkenyl group, or an ether; n is 0, 1, 2, or 3. Such amines may include any one or combination of amines provided herein. Additional, or preferred amines include, but are not limited to, N,N,N′-trimethylaminoethylethanolamine; 2-[[2-[2-(dimethylamino)ethoxy]ethyl]methylamino]ethanol; Bis-(2-dimethylaminoethyl)ether; N,N,N′,N″,N″-pentamethyldipropylenetriamine; 1,1,4,7,10,10-hexamethyltriethylenetetraamine; Bis(3-dimethylaminopropyl-n, n-dimethylpropanediamine; and/or N,N′,N″-dimethylaminopropylhexahydrotriazine.

Useful organic acids non-exclusively include a carboxylic acid, dicarboxylic acid, phenol, polymeric acid or combinations thereof. Examples of these organic acids non-exclusively include formic, acetic, propionic, butyric, caproic, citric, isocaprotic, 2-ethylhexanoic, caprylic, cyanoacetic pyruvic, benzoic, oxalic, malonic, succinic, adipic, azelaic, trifluoroacetic, methanesulfonic, benzenesulfonic acid, polymeric acid such as polyacrylic acid, polymethacrylic acid and the like and mixtures thereof. A preferred group comprises formic, acetic, caprotic, citric, isocaprotic, 2-ethylhexanoic acid, phenol, polymeric acid, and combinations thereof. The acid reacts with the amine to form an adduct catalyst which has a lower reactivity toward certain blowing agents, such as hydrohaloolefins, compared to a catalysts which is the amine alone.

The adduct is formed by pre-reacting the amine and the organic acid prior to inclusion of the resulting adduct in the polyol premix composition. In the usual case, sufficient organic acid is reacted with the selected amine to fully react with the amine. This is usually at least a stoichiometric amount of organic acid for the quantity of amine. Alternatively, the amine and organic acid can be added to the polyol separately, forming the adduct in-situ, prior to the introduction of the blowing agent into the polyol premix.

Commercially available acid-blocked catalysts can also be used, such as Polycat 201. Polycat 203, Polycat 204, Polycat 218, or Polycat SA-1 from Air Products, Niax A-577 from Momentive

The amine-organic acid adduct catalyst may be present in the polyol premix composition in an amount of from about 0.1 wt. % to about 10 wt. %, preferably in an amount of from about 0.2 wt. % to about 8.0 wt. %, preferably from about 0.2 wt. % to about 7.0 wt. %, and more preferably from about 0.3 wt. % to about 6.0 wt. %, by weight of the polyol premix composition. Such amounts are non-limiting to the present invention. To this end, the quantity of the foregoing catalysts can vary widely, and the appropriate or effective amount can be easily be determined by those skilled in the art.

The polyol premix composition may also (or alternatively) include one or more catalysts that are non-amines. In one embodiment, the non-amine catalyst(s) may be inorgano- or organo-metallic compounds. Useful inorgano- or organo-metallic compounds include, but are not limited to, organic salts, Lewis acid halides, or the like, of any metal, including, but not limited to, transition metals, post-transition (poor) metals, rare earth metals (e.g. lanthanides), metalloids, alkali metals, alkaline earth metals, or the like. Examples of such metals may include, but are not limited to, bismuth, lead, tin, zinc, chromium, cobalt, copper, iron, manganese, magnesium, potassium, sodium, titanium, mercury, zinc, antimony, uranium, cadmium, thorium, aluminum, nickel, cerium, molybdenum, vanadium, zirconium, or combinations thereof.

Non-exclusive examples of such inorgano- or organo-metallic catalysts include, but are not limited to, lead 2-ethylhexoate, lead benzoate, lead naphthanate, antimony glycolate, tin salts of carboxylic acids, dialkyl tin salts of carboxylic acids, bismuth salts of carboxylic acids, potassium acetate, potassium octoate, potassium 2-ethylhexoate, potassium salts of carboxylic acids, zinc salts of carboxylic acids, zinc 2-ethylhexanoate, glycine salts, alkali metal carboxylic acid salts, sodium N-(2-hydroxy-5-nonylphenol)methyl-N-methylglycinate, tin (II) 2-ethylhexanoate, dibutyltin dilaurate, bismuth 2-ethylhexanoate along with othe bismuth salts as commercialized as Bicat 8106, Kkat xk651, Pucat 25, or combinations thereof.

In certain aspects, such metallic catalysts are precipitant resistant in the presence of the premix formulation or water. In further aspects, the amine catalysts discussed above may be used in combination with at least one, and preferably at least two, metal catalysts according to the invention as described above.

These catalysts may be present in the polyol premix composition in an amount of from about 0.001 wt. % to about 5 wt. %, preferably from about 0.005 wt. % to about 3.0 wt. %, preferably from about 0.01 wt. % to about 2.0 wt. %, and more preferably from about 0.01 wt. % to about 1.0 wt. %, by weight of the polyol premix composition. Such amounts are non-limiting to the present invention. To this end, the quantity of the foregoing catalysts can vary widely, and the appropriate or effective amount can be easily be determined by those skilled in the art.

D. Surfactant

The polyol premix composition preferably also contains at least one surfactant, in certain embodiments a silicone surfactant. The silicone surfactant is preferably used to form a foam from the mixture, particularly an integral skin foam, as well as to control the size of the bubbles of the foam so that a foam of a desired cell structure is obtained. Preferably, a foam with small bubbles or cells therein of uniform size is desired since it has the most desirable physical properties such as compressive strength. Also, it is critical to have a foam with stable cells which do not collapse prior to forming or during foam rise and are resistant to abrasion.

Silicone surfactants for use in the preparation of polyurethane foams are available under a number of trade names known to those skilled in this art. Such materials have been found to be applicable over a wide range of formulations allowing uniform cell formation and maximum gas entrapment to achieve very low density foam structures. The preferred silicone surfactant comprises a polysiloxane polyoxyalkylene block co-polymer. Some representative silicone surfactants useful for this invention are Momentive's L-1500, L-1501, L-1504, L-1506, L-1580, L-1593, L-1603; L-5302; Air Products DC193, DC2525, DC3042, DC3043, DC5179, LK665, SI 4202 and SI 4203 and TEGOSTAB B8905, B8930, B8993, B8946PF, B8592, B8960, B8948 and Gorapur IMR 852 from Evonik Industries AG of Essen, Germany. The silicone surfactant component is usually present in the polyol premix composition in an amount of from about 0.1 wt. % to about 5.0 wt. %, preferably from about 0.1 wt. % to about 3.0 wt. %, and more preferably from about 0.1 wt. % to about 2.0 wt. %, by weight of the polyol premix composition. Such amounts are non-limiting to the present invention. To this end, the quantity of the foregoing surfactants can vary widely, and the appropriate or effective amount can be easily be determined by those skilled in the art

The polyol premix composition may optionally (or alternatively) contain a non-silicone surfactant, such as a non-silicone, non-ionic surfactant. Such surfactants may be used alone (in the absence of a silicone surfactant) or in conjunction with a silicone surfactant. Non-limiting examples of non-silicone surfactants may include oxyethylated alkylphenols, oxyethylated fatty alcohols, paraffin oils, castor oil esters, ricinoleic acid esters, turkey red oil, groundnut oil, paraffins, and fatty alcohols. A preferred non-silicone non-ionic surfactant is LK-443, or LK-221 which is commercially available from Air Products Corporation or Verasurf 504 from Dow Chemical, Corporation. When a non-silicone, non-ionic surfactant used, it is usually present in the polyol premix composition in an amount of from about 0.1 wt. % to about 5.0 wt. %, preferably from about 0.1 wt. % to about 3.0 wt. %, and more preferably from about 0.1 wt. % to about 2.0 wt. %, by weight of the polyol premix composition. Such amounts are non-limiting to the present invention. To this end, the quantity of the foregoing surfactants can vary widely, and the appropriate or effective amount can be easily be determined by those skilled in the art.

E. Other Components

In further embodiments, the foamable compositions and foam premix compositions of the present invention may include one or more optional additional compounds. Such additional components may include, but are not limited to, stabilizers, chain extending agents, antioxidants, cross linking agents, abrasion resistant agents, polymer modifiers, toughening agents, colorants, dyes, pigments, solubility enhancers, rheology modifiers, plasticizing agents, flammability suppressants, antibacterial agents, viscosity reduction modifiers, fillers, vapor pressure modifiers, antistatic agents, mold releasing agents, and the like. In certain preferred embodiments, dispersing agents, cell stabilizers, and other additives may also be incorporated into the compositions of the present invention.

Chain extending agents that may be employed with the present invention include those having one or more, in certain preferred aspects, at least two functional groups bearing active hydrogen atoms. Non-limiting examples of chain extending agents that may be used in the manufacture of integral skin foams include ethylene glycol, diethylene glycol, propylene glycol, dipropylene glycol, or 1,4-butanediol and mixtures thereof.

Cross linking agents may include any agent adapted to increase cross-linking in the foam, which improves overall tear resistance. In one non-limiting example, the cross linking agent is an alcohol. Non-limiting examples of alcohols useful as a cross-linking agent include aliphatic alcohols and polyalcohols. Preferred aliphatic alcohols may include ethyl alcohol, 1- or 2-propyl alcohol, butyl alcohols, and certain pentyl alcohols. Polyalcohols may include ethylene glycol, propylene glycol, 1,4-butanediol and glycerine. Cross linking agents may also include an alcohol having from about 10 to about 20 carbons or mixtures thereof. In certain preferred embodiments, the cross linking alcohols can be produced via the oxo process and are referred to as oxo-alcohols. Non-limiting examples of commercially available products include LIAL 125 from Chemica Augusta Spa or NEODOL® 25 produced by Shell.

With respect to nucleating agents, all known compounds and materials having nucleating functionality are available for use in the present invention, including particularly talc.

Other compounds and/or components that modulate a particular property of the compositions (such as cost for example) may also be included in the present compositions, and the presence of all such compounds and components is within the broad scope of the invention. Additional components that are preferably included in the integral skin foam applications of the present invention are especially preferred.

Certain commercially available products incorporate several components that provide multiple functionalities when used according to the present invention. For example the commercially available product sold under the trade designation Elastopan S7089/144 by BASF contains catalyst, surfactant, chain extending agent and about 3.43% by weight of water.

F. Preferred MDI Foamable Compositions

As mentioned above, the preferred isocyanates for use in the foamable compositions for making the integral skin foam, including the shoe sole foam, of the present invention are of MDI-based isocyanates. Preferred foamable compositons include the those identified below.

1. ISF and Shoe Sole Foams With 1233zd Blowing Agent

Preferred foamable compositions of the present invention according to one embodiment, particularly including foamable compositions for forming integral skin foams having the preferred combinations of density, hardness and other properties mentioned above, comprise:
(i) polyol component comprising, preferably in consisting essentially of, one or more polyols, preferably polyester polyols, having: (a) an average functionality of from about 2 to about 4; (b) an OH number (average) of from about 20 to about 35; and optionally but preferably an average molecular weight of from about 3000 to about 8000;
(ii) isocyanate component comprising, and preferably consisting essentially of, one or more MDI-based isocyanates with an NCO % of from about 18 to about 24, wherein the amount of said isocuyanate is preferably present in an amount relative to the polyol to provide an index of from about 80 to about 120;
(iii) blowing agent comprising (a) chemical blowing agent preferably comprising at least about 90% water; and (b) and physical blowing agent comprising, preferably in major proportion by weight, of one or more trifluoro,monochloropropenes (HFO-1233), preferably transHFO-1233zd.

Preferred foamable compositions of the present invention according to one embodiment, particularly including foamable compositions for forming integral skin foams having the preferred combinations of density, hardness and other properties mentioned above, comprise:
(i) polyol component comprising, preferably in consisting essentially of, one or more polyols, preferably polyester polyols, having: (a) an average functionality of from about 2 to about 3; (b) an OH number (average) of from about 20 to about 35; and optionally but preferably an average molecular weight of from about 3000 to about 8000;
(ii) isocyanate component comprising, and preferably consisting essentially of, one or more MDI-based isocyanates with an NCO % of from about 18 to about 24, wherein the amount of said isocuyanate is preferably present in an amount relative to the polyol to provide an index of from about 80 to about 120;
(iii) blowing agent comprising (a) chemical blowing agent preferably comprising at least about 90% water; and (b) and physical blowing agent comprising, preferably in major proportion by weight, of one or more trifluoro,monochloropropenes (HFO-1233), preferably transHFO-1233zd.

Preferred foamable compositions of the present invention according to one embodiment, particularly including foamable compositions for forming integral skin foams having the preferred combinations of density, hardness and other properties mentioned above, comprise:
(i) polyol component comprising, preferably in consisting essentially of, one or more polyols, preferably polyester polyols, having: (a) an average functionality of from about 2 to about 4; (b) an OH number (average) of from about 25 to about 30; and optionally but preferably an average molecular weight of from about 3000 to about 8000;
(ii) isocyanate component comprising, and preferably consisting essentially of, one or more MDI-based isocyanates with an NCO % of from about 18 to about 24, wherein the amount of said isocuyanate is preferably present in an amount relative to the polyol to provide an index of from about 80 to about 120;
(iii) blowing agent comprising (a) chemical blowing agent preferably comprising at least about 90% water; and (b) and physical blowing agent comprising, preferably in major proportion by weight, of one or more trifluoro,monochloropropenes (HFO-1233), preferably transHFO-1233zd.

Preferred foamable compositions of the present invention according to one embodiment, particularly including foamable compositions for forming integral skin foams having the preferred combinations of density, hardness and other properties mentioned above, comprise:
(i) polyol component comprising, preferably in consisting essentially of, one or more polyols, preferably polyester polyols, having: (a) an average functionality of from about 2 to about 3; (b) an OH number (average) of from about 25 to about 30; and optionally but preferably an average molecular weight of from about 3000 to about 8000;
(ii) isocyanate component comprising, and preferably consisting essentially of, one or more MDI-based isocyanates with an NCO % of from about 18 to about 24, wherein the amount of said isocuyanate is preferably present in an amount relative to the polyol to provide an index of from about 80 to about 120;
(iii) blowing agent comprising (a) chemical blowing agent preferably comprising at least about 90% water; and (b) and physical blowing agent comprising, preferably in major proportion by weight, of one or more trifluoro,monochloropropenes (HFO-1233), preferably transHFO-1233zd.

Preferred foamable compositions of the present invention according to one embodiment, particularly including foamable compositions for forming integral skin foams having the preferred combinations of density, hardness and other properties mentioned above, comprise:
(i) polyol component comprising, preferably in consisting essentially of, one or more polyols, preferably polyester polyols, having: (a) an average functionality of from about 2 to about 4; (b) an OH number (average) of from about 20 to about 35; and optionally but preferably an average molecular weight of from about 3000 to about 8000;
(ii) isocyanate component comprising, and preferably consisting essentially of, one or more MDI-based isocyanates with an NCO % of from about 18 to about 22, wherein the amount of said isocuyanate is preferably present in an amount relative to the polyol to provide an index of from about 80 to about 120;
(iii) blowing agent comprising (a) chemical blowing agent preferably comprising at least about 90% water; and (b) and physical blowing agent comprising, preferably in major proportion by weight, of one or more trifluoro,monochloropropenes (HFO-1233), preferably transHFO-1233zd.

Preferred foamable compositions of the present invention according to one embodiment, particularly including foamable compositions for forming integral skin foams having the preferred combinations of density, hardness and other properties mentioned above, comprise:
(i) polyol component comprising, preferably in consisting essentially of, one or more polyols, preferably polyester polyols, having: (a) an average functionality of from about 2 to about 3; (b) an OH number (average) of from about 20 to about 35; and optionally but preferably an average molecular weight of from about 3000 to about 8000;
(ii) isocyanate component comprising, and preferably consisting essentially of, one or more MDI-based isocyanates with an NCO % of from about 18 to about 22, wherein the amount of said isocuyanate is preferably present in an amount relative to the polyol to provide an index of from about 80 to about 120;
(iii) blowing agent comprising (a) chemical blowing agent preferably comprising at least about 90% water; and (b) and physical blowing agent comprising, preferably in major proportion by weight, of one or more trifluoro,monochloropropenes (HFO-1233), preferably transHFO-1233zd.

Preferred foamable compositions of the present invention according to one embodiment, particularly including foamable compositions for forming integral skin foams having the preferred combinations of density, hardness and other properties mentioned above, comprise:
(i) polyol component comprising, preferably in consisting essentially of, one or more polyols, preferably polyester polyols, having: (a) an average functionality of from about 2 to about 4; (b) an OH number (average) of from about 25 to about 30; and optionally but preferably an average molecular weight of from about 3000 to about 8000;
(ii) isocyanate component comprising, and preferably consisting essentially of, one or more MDI-based isocyanates with an NCO % of from about 18 to about 22, wherein the amount of said isocuyanate is preferably present in an amount relative to the polyol to provide an index of from about 80 to about 120;
(iii) blowing agent comprising (a) chemical blowing agent preferably comprising at least about 90% water; and (b) and physical blowing agent comprising, preferably in major proportion by weight, of one or more trifluoro,monochloropropenes (HFO-1233), preferably transHFO-1233zd.

Preferred foamable compositions of the present invention according to one embodiment, particularly including foamable compositions for forming integral skin foams having the preferred combinations of density, hardness and other properties mentioned above, comprise:
(i) polyol component comprising, preferably in consisting essentially of, one or more polyols, preferably polyester polyols, having: (a) an average functionality of from about 2 to about 3; (b) an OH number (average) of from about 25 to about 30; and optionally but preferably an average molecular weight of from about 3000 to about 8000;
(ii) isocyanate component comprising, and preferably consisting essentially of, one or more MD I-based isocyanates with an NCO % of from about 18 to about 22, wherein the amount of said isocuyanate is preferably present in an amount relative to the polyol to provide an index of from about 80 to about 120;
(iii) blowing agent comprising (a) chemical blowing agent preferably comprising at least about 90% water; and (b) and physical blowing agent comprising, preferably in major proportion by weight, of one or more trifluoro,monochloropropenes (HFO-1233), preferably transHFO-1233zd.

Preferred foamable compositions of the present invention according to one embodiment, particularly including foamable compositions for forming integral skin foams having the preferred combinations of density, hardness and other properties mentioned above, comprise:
(i) polyol component comprising, preferably in consisting essentially of, one or more polyols, preferably polyester polyols, having: (a) an average functionality of from about 2 to about 4; (b) an OH number (average) of from about 20 to about 35; and optionally but preferably an average molecular weight of from about 3000 to about 8000;
(ii) isocyanate component comprising, and preferably consisting essentially of, one or more MDI-based isocyanates with an NCO % of from about 18 to about 24, wherein the amount of said isocuyanate is preferably present in an amount relative to the polyol to provide an index of from about 90 to about 110;
(iii) blowing agent comprising (a) chemical blowing agent preferably comprising at least about 90% water; and (b) and physical blowing agent comprising, preferably in major proportion by weight, of one or more trifluoro,monochloropropenes (HFO-1233), preferably transHFO-1233zd.

Preferred foamable compositions of the present invention according to one embodiment, particularly including foamable compositions for forming integral skin foams having the preferred combinations of density, hardness and other properties mentioned above, comprise:
(i) polyol component comprising, preferably in consisting essentially of, one or more polyols, preferably polyester polyols, having: (a) an average functionality of from about 2 to about 3; (b) an OH number (average) of from about 20 to about 35; and optionally but preferably an average molecular weight of from about 3000 to about 8000;
(ii) isocyanate component comprising, and preferably consisting essentially of, one or more MDI-based isocyanates with an NCO % of from about 18 to about 24, wherein the amount of said isocuyanate is preferably present in an amount relative to the polyol to provide an index of from about 90 to about 110;
(iii) blowing agent comprising (a) chemical blowing agent preferably comprising at least about 90% water; and (b) and physical blowing agent comprising, preferably in major proportion by weight, of one or more trifluoro,monochloropropenes (HFO-1233), preferably transHFO-1233zd.

Preferred foamable compositions of the present invention according to one embodiment, particularly including foamable compositions for forming integral skin foams having the preferred combinations of density, hardness and other properties mentioned above, comprise:
(i) polyol component comprising, preferably in consisting essentially of, one or more polyols, preferably polyester polyols, having: (a) an average functionality of from about 2 to about 4; (b) an OH number (average) of from about 25 to about 30; and optionally but preferably an average molecular weight of from about 3000 to about 8000;
(ii) isocyanate component comprising, and preferably consisting essentially of, one or more MDI-based isocyanates with an NCO % of from about 18 to about 24, wherein the amount of said isocuyanate is preferably present in an amount relative to the polyol to provide an index of from about 90 to about 110;
(iii) blowing agent comprising (a) chemical blowing agent preferably comprising at least about 90% water; and (b) and physical blowing agent comprising, preferably in major proportion by weight, of one or more trifluoro,monochloropropenes (HFO-1233), preferably transHFO-1233zd.

Preferred foamable compositions of the present invention according to one embodiment, particularly including foamable compositions for forming integral skin foams having the preferred combinations of density, hardness and other properties mentioned above, comprise:
(i) polyol component comprising, preferably in consisting essentially of, one or more polyols, preferably polyester polyols, having: (a) an average functionality of from about 2 to about 3; (b) an OH number (average) of from about 25 to about 30; and optionally but preferably an average molecular weight of from about 3000 to about 8000;
(ii) isocyanate component comprising, and preferably consisting essentially of, one or more MDI-based isocyanates with an NCO % of from about 18 to about 24, wherein the amount of said isocuyanate is preferably present in an amount relative to the polyol to provide an index of from about 90 to about 110;
(iii) blowing agent comprising (a) chemical blowing agent preferably comprising at least about 90% water; and (b) and physical blowing agent comprising, preferably in major proportion by weight, of one or more trifluoro,monochloropropenes (HFO-1233), preferably transHFO-1233zd.

Preferred foamable compositions of the present invention according to one embodiment, particularly including foamable compositions for forming integral skin foams having the preferred combinations of density, hardness and other properties mentioned above, comprise:
(i) polyol component comprising, preferably in consisting essentially of, one or more polyols, preferably polyester polyols, having: (a) an average functionality of from about 2 to about 4; (b) an OH number (average) of from about 20 to about 35; and optionally but preferably an average molecular weight of from about 3000 to about 8000;
(ii) isocyanate component comprising, and preferably consisting essentially of, one or more MDI-based isocyanates with an NCO % of from about 18 to about 22, wherein the amount of said isocuyanate is preferably present in an amount relative to the polyol to provide an index of from about 90 to about 110;
(iii) blowing agent comprising (a) chemical blowing agent preferably comprising at least about 90% water; and (b) and physical blowing agent comprising, preferably in major proportion by weight, of one or more trifluoro,monochloropropenes (HFO-1233), preferably transHFO-1233zd.

Preferred foamable compositions of the present invention according to one embodiment, particularly including foamable compositions for forming integral skin foams having the preferred combinations of density, hardness and other properties mentioned above, comprise:
(i) polyol component comprising, preferably in consisting essentially of, one or more polyols, preferably polyester polyols, having: (a) an average functionality of from about 2 to about 3; (b) an OH number (average) of from about 20 to about 35; and optionally but preferably an average molecular weight of from about 3000 to about 8000;
(ii) isocyanate component comprising, and preferably consisting essentially of, one or more MDI-based isocyanates with an NCO % of from about 18 to about 22, wherein the amount of said isocuyanate is preferably present in an amount relative to the polyol to provide an index of from about 90 to about 110;
(iii) blowing agent comprising (a) chemical blowing agent preferably comprising at least about 90% water; and (b) and physical blowing agent comprising, preferably in major proportion by weight, of one or more trifluoro,monochloropropenes (HFO-1233), preferably transHFO-1233zd.

Preferred foamable compositions of the present invention according to one embodiment, particularly including foamable compositions for forming integral skin foams having the preferred combinations of density, hardness and other properties mentioned above, comprise:
(i) polyol component comprising, preferably in consisting essentially of, one or more polyols, preferably polyester polyols, having: (a) an average functionality of from about 2 to about 4; (b) an OH number (average) of from about 25 to about 30; and optionally but preferably an average molecular weight of from about 3000 to about 8000;
(ii) isocyanate component comprising, and preferably consisting essentially of, one or more MDI-based isocyanates with an NCO % of from about 18 to about 22, wherein the amount of said isocuyanate is preferably present in an amount relative to the polyol to provide an index of from about 90 to about 110;
(iii) blowing agent comprising (a) chemical blowing agent preferably comprising at least about 90% water; and (b) and physical blowing agent comprising, preferably in major proportion by weight, of one or more trifluoro,monochloropropenes (HFO-1233), preferably transHFO-1233zd.

Preferred foamable compositions of the present invention according to one embodiment, particularly including foamable compositions for forming integral skin foams having the preferred combinations of density, hardness and other properties mentioned above, comprise:
(i) polyol component comprising, preferably in consisting essentially of, one or more polyols, preferably polyester polyols, having: (a) an average functionality of from about 2 to about 3; (b) an OH number (average) of from about 25 to about 30; and optionally but preferably an average molecular weight of from about 3000 to about 8000;
(ii) isocyanate component comprising, and preferably consisting essentially of, one or more MDI-based isocyanates with an NCO % of from about 18 to about 22, wherein the amount of said isocuyanate is preferably present in an amount relative to the polyol to provide an index of from about 90 to about 110;
(iii) blowing agent comprising (a) chemical blowing agent preferably comprising at least about 90% water; and (b) and physical blowing agent comprising, preferably in major proportion by weight, of one or more trifluoro,monochloropropenes (HFO-1233), preferably transHFO-1233zd.

Preferred foamable compositions of the present invention according to one embodiment, particularly including foamable compositions for forming integral skin foams having the preferred combinations of density, hardness and other properties mentioned above, comprise:
(i) polyol component comprising, preferably in consisting essentially of, one or more polyols, preferably polyester polyols, having: (a) an average functionality of from about 2 to about 4; (b) an OH number (average) of from about 20 to about 35; and optionally but preferably an average molecular weight of from about 3000 to about 8000;
(ii) isocyanate component comprising, and preferably consisting essentially of, one or more MDI-based isocyanates with an NCO % of from about 18 to about 24, wherein the amount of said isocuyanate is preferably present in an amount relative to the polyol to provide an index of from about 80 to about 120;
(iii) blowing agent comprising (a) chemical blowing agent preferably comprising at least about 90% water; and (b) and physical blowing agent comprising from about 1 to about 15 php of one or more trifluoro,monochloropropenes (HFO-1233), preferably transHFO-1233zd.

Preferred foamable compositions of the present invention according to one embodiment, particularly including foamable compositions for forming integral skin foams having the preferred combinations of density, hardness and other properties mentioned above, comprise:
(i) polyol component comprising, preferably in consisting essentially of, one or more polyols, preferably polyester polyols, having: (a) an average functionality of from about 2 to about 3; (b) an OH number (average) of from about 20 to about 35; and optionally but preferably an average molecular weight of from about 3000 to about 8000;
(ii) isocyanate component comprising, and preferably consisting essentially of, one or more MDI-based isocyanates with an NCO % of from about 18 to about 24, wherein the amount of said isocuyanate is preferably present in an amount relative to the polyol to provide an index of from about 80 to about 120;
(iii) blowing agent comprising (a) chemical blowing agent preferably comprising at least about 90% water; and (b) and physical blowing agent comprising from about 1 to about 15 php of one or more trifluoro,monochloropropenes (HFO-1233), preferably transHFO-1233zd.

Preferred foamable compositions of the present invention according to one embodiment, particularly including foamable compositions for forming integral skin foams having the preferred combinations of density, hardness and other properties mentioned above, comprise:
(i) polyol component comprising, preferably in consisting essentially of, one or more polyols, preferably polyester polyols, having: (a) an average functionality of from about 2 to about 4; (b) an OH number (average) of from about 25 to about 30; and optionally but preferably an average molecular weight of from about 3000 to about 8000;
(ii) isocyanate component comprising, and preferably consisting essentially of, one or more MDI-based isocyanates with an NCO % of from about 18 to about 24, wherein the amount of said isocuyanate is preferably present in an amount relative to the polyol to provide an index of from about 80 to about 120;
(iii) blowing agent comprising (a) chemical blowing agent preferably comprising at least about 90% water; and (b) and physical blowing agent comprising from about 1 to about 15 php, of one or more trifluoro,monochloropropenes (HFO-1233), preferably transHFO-1233zd.

Preferred foamable compositions of the present invention according to one embodiment, particularly including foamable compositions for forming integral skin foams having the preferred combinations of density, hardness and other properties mentioned above, comprise:
(i) polyol component comprising, preferably in consisting essentially of, one or more polyols, preferably polyester polyols, having: (a) an average functionality of from about 2 to about 3; (b) an OH number (average) of from about 25 to about 30; and optionally but preferably an average molecular weight of from about 3000 to about 8000;
(ii) isocyanate component comprising, and preferably consisting essentially of, one or more MDI-based isocyanates with an NCO % of from about 18 to about 24, wherein the amount of said isocuyanate is preferably present in an amount relative to the polyol to provide an index of from about 80 to about 120;
(iii) blowing agent comprising (a) chemical blowing agent preferably comprising at least about 90% water; and (b) and physical blowing agent comprising from about 1 to about 15 php of one or more trifluoro,monochloropropenes (HFO-1233), preferably transHFO-1233zd.

Preferred foamable compositions of the present invention according to one embodiment, particularly including foamable compositions for forming integral skin foams having the preferred combinations of density, hardness and other properties mentioned above, comprise:
(i) polyol component comprising, preferably in consisting essentially of, one or more polyols, preferably polyester polyols, having: (a) an average functionality of from about 2 to about 4; (b) an OH number (average) of from about 20 to about 35; and optionally but preferably an average molecular weight of from about 3000 to about 8000;
(ii) isocyanate component comprising, and preferably consisting essentially of, one or more MDI-based isocyanates with an NCO % of from about 18 to about 22, wherein the amount of said isocuyanate is preferably present in an amount relative to the polyol to provide an index of from about 80 to about 120;
(iii) blowing agent comprising (a) chemical blowing agent preferably comprising at least about 90% water; and (b) and physical blowing agent comprising from about 1 to about 15 php of one or more trifluoro,monochloropropenes (HFO-1233), preferably transHFO-1233zd.

Preferred foamable compositions of the present invention according to one embodiment, particularly including foamable compositions for forming integral skin foams having the preferred combinations of density, hardness and other properties mentioned above, comprise:
(i) polyol component comprising, preferably in consisting essentially of, one or more polyols, preferably polyester polyols, having: (a) an average functionality of from about 2 to about 3; (b) an OH number (average) of from about 20 to about 35; and optionally but preferably an average molecular weight of from about 3000 to about 8000;
(ii) isocyanate component comprising, and preferably consisting essentially of, one or more MDI-based isocyanates with an NCO % of from about 18 to about 22, wherein the amount of said isocuyanate is preferably present in an amount relative to the polyol to provide an index of from about 80 to about 120;
(iii) blowing agent comprising (a) chemical blowing agent preferably comprising at least about 90% water; and (b) and physical blowing agent comprising from about 1 to about 15 php of one or more trifluoro,monochloropropenes (HFO-1233), preferably transHFO-1233zd.

Preferred foamable compositions of the present invention according to one embodiment, particularly including foamable compositions for forming integral skin foams having the preferred combinations of density, hardness and other properties mentioned above, comprise:
(i) polyol component comprising, preferably in consisting essentially of, one or more polyols, preferably polyester polyols, having: (a) an average functionality of from about 2 to about 4; (b) an OH number (average) of from about 25 to about 30; and optionally but preferably an average molecular weight of from about 3000 to about 8000;
(ii) isocyanate component comprising, and preferably consisting essentially of, one or more MDI-based isocyanates with an NCO % of from about 18 to about 22, wherein the amount of said isocuyanate is preferably present in an amount relative to the polyol to provide an index of from about 80 to about 120;
(iii) blowing agent comprising (a) chemical blowing agent preferably comprising at least about 90% water; and (b) and physical blowing agent comprising from about 1 to about 15 php of one or more trifluoro,monochloropropenes (HFO-1233), preferably transHFO-1233zd.

Preferred foamable compositions of the present invention according to one embodiment, particularly including foamable compositions for forming integral skin foams having the preferred combinations of density, hardness and other properties mentioned above, comprise:
(i) polyol component comprising, preferably in consisting essentially of, one or more polyols, preferably polyester polyols, having: (a) an average functionality of from about 2 to about 3; (b) an OH number (average) of from about 25 to about 30; and optionally but preferably an average molecular weight of from about 3000 to about 8000;
(ii) isocyanate component comprising, and preferably consisting essentially of, one or more MDI-based isocyanates with an NCO % of from about 18 to about 22, wherein the amount of said isocuyanate is preferably present in an amount relative to the polyol to provide an index of from about 80 to about 120;
(iii) blowing agent comprising (a) chemical blowing agent preferably comprising at least about 90% water; and (b) and physical blowing agent comprising from about 1 to about 15 php of one or more trifluoro,monochloropropenes (HFO-1233), preferably transHFO-1233zd.

Preferred foamable compositions of the present invention according to one embodiment, particularly including foamable compositions for forming integral skin foams having the preferred combinations of density, hardness and other properties mentioned above, comprise:
(i) polyol component comprising, preferably in consisting essentially of, one or more polyols, preferably polyester polyols, having: (a) an average functionality of from about 2 to about 4; (b) an OH number (average) of from about 20 to about 35; and optionally but preferably an average molecular weight of from about 3000 to about 8000;
(ii) isocyanate component comprising, and preferably consisting essentially of, one or more MD I-based isocyanates with an NCO % of from about 18 to about 24, wherein the amount of said isocuyanate is preferably present in an amount relative to the polyol to provide an index of from about 90 to about 110;
(iii) blowing agent comprising (a) chemical blowing agent preferably comprising at least about 90% water; and (b) and physical blowing agent comprising from about 1 to about 15 php of one or more trifluoro,monochloropropenes (HFO-1233), preferably transHFO-1233zd.

Preferred foamable compositions of the present invention according to one embodiment, particularly including foamable compositions for forming integral skin foams having the preferred combinations of density, hardness and other properties mentioned above, comprise:
(i) polyol component comprising, preferably in consisting essentially of, one or more polyols, preferably polyester polyols, having: (a) an average functionality of from about 2 to about 3; (b) an OH number (average) of from about 20 to about 35; and optionally but preferably an average molecular weight of from about 3000 to about 8000;
(ii) isocyanate component comprising, and preferably consisting essentially of, one or more MDI-based isocyanates with an NCO % of from about 18 to about 24, wherein the amount of said isocuyanate is preferably present in an amount relative to the polyol to provide an index of from about 90 to about 110;
(iii) blowing agent comprising (a) chemical blowing agent preferably comprising at least about 90% water; and (b) and physical blowing agent comprising from about 1 to about 15 php of one or more trifluoro,monochloropropenes (HFO-1233), preferably transHFO-1233zd.

Preferred foamable compositions of the present invention according to one embodiment, particularly including foamable compositions for forming integral skin foams having the preferred combinations of density, hardness and other properties mentioned above, comprise:
(i) polyol component comprising, preferably in consisting essentially of, one or more polyols, preferably polyester polyols, having: (a) an average functionality of from about 2 to about 4; (b) an OH number (average) of from about 25 to about 30; and optionally but preferably an average molecular weight of from about 3000 to about 8000;
(ii) isocyanate component comprising, and preferably consisting essentially of, one or more MDI-based isocyanates with an NCO % of from about 18 to about 24, wherein the amount of said isocuyanate is preferably present in an amount relative to the polyol to provide an index of from about 90 to about 110;
(iii) blowing agent comprising (a) chemical blowing agent preferably comprising at least about 90% water; and (b) and physical blowing agent comprising from about 1 to about 15 php of one or more trifluoro,monochloropropenes (HFO-1233), preferably transHFO-1233zd.

Preferred foamable compositions of the present invention according to one embodiment, particularly including foamable compositions for forming integral skin foams having the preferred combinations of density, hardness and other properties mentioned above, comprise:
(i) polyol component comprising, preferably in consisting essentially of, one or more polyols, preferably polyester polyols, having: (a) an average functionality of from about 2 to about 3; (b) an OH number (average) of from about 25 to about 30; and optionally but preferably an average molecular weight of from about 3000 to about 8000;
(ii) isocyanate component comprising, and preferably consisting essentially of, one or more MDI-based isocyanates with an NCO % of from about 18 to about 24, wherein the amount of said isocuyanate is preferably present in an amount relative to the polyol to provide an index of from about 90 to about 110;
(iii) blowing agent comprising (a) chemical blowing agent preferably comprising at least about 90% water; and (b) and physical blowing agent comprising from about 1 to about 15 php of one or more trifluoro,monochloropropenes (HFO-1233), preferably transHFO-1233zd.

Preferred foamable compositions of the present invention according to one embodiment, particularly including foamable compositions for forming integral skin foams having the preferred combinations of density, hardness and other properties mentioned above, comprise:
(i) polyol component comprising, preferably in consisting essentially of, one or more polyols, preferably polyester polyols, having: (a) an average functionality of from about 2 to about 4; (b) an OH number (average) of from about 20 to about 35; and optionally but preferably an average molecular weight of from about 3000 to about 8000;
(ii) isocyanate component comprising, and preferably consisting essentially of, one or more MDI-based isocyanates with an NCO % of from about 18 to about 22, wherein the amount of said isocuyanate is preferably present in an amount relative to the polyol to provide an index of from about 90 to about 110;
(iii) blowing agent comprising (a) chemical blowing agent preferably comprising at least about 90% water; and (b) and physical blowing agent comprising from about 1 to about 15 php of one or more trifluoro,monochloropropenes (HFO-1233), preferably transHFO-1233zd.

Preferred foamable compositions of the present invention according to one embodiment, particularly including foamable compositions for forming integral skin foams having the preferred combinations of density, hardness and other properties mentioned above, comprise:
(i) polyol component comprising, preferably in consisting essentially of, one or more polyols, preferably polyester polyols, having: (a) an average functionality of from about 2 to about 3; (b) an OH number (average) of from about 20 to about 35; and optionally but preferably an average molecular weight of from about 3000 to about 8000;
(ii) isocyanate component comprising, and preferably consisting essentially of, one or more MDI-based isocyanates with an NCO % of from about 18 to about 22, wherein the amount of said isocuyanate is preferably present in an amount relative to the polyol to provide an index of from about 90 to about 110;
(iii) blowing agent comprising (a) chemical blowing agent preferably comprising at least about 90% water; and (b) and physical blowing agent comprising from about 1 to about 15 php of one or more trifluoro,monochloropropenes (HFO-1233), preferably transHFO-1233zd.

Preferred foamable compositions of the present invention according to one embodiment, particularly including foamable compositions for forming integral skin foams having the preferred combinations of density, hardness and other properties mentioned above, comprise:
(i) polyol component comprising, preferably in consisting essentially of, one or more polyols, preferably polyester polyols, having: (a) an average functionality of from about 2 to about 4; (b) an OH number (average) of from about 25 to about 30; and optionally but preferably an average molecular weight of from about 3000 to about 8000;
(ii) isocyanate component comprising, and preferably consisting essentially of, one or more MDI-based isocyanates with an NCO % of from about 18 to about 22, wherein the amount of said isocuyanate is preferably present in an amount relative to the polyol to provide an index of from about 90 to about 110;
(iii) blowing agent comprising (a) chemical blowing agent preferably comprising at least about 90% water; and (b) and physical blowing agent comprising from about 1 to about 15 php of one or more trifluoro,monochloropropenes (HFO-1233), preferably transHFO-1233zd.

Preferred foamable compositions of the present invention according to one embodiment, particularly including foamable compositions for forming integral skin foams having the preferred combinations of density, hardness and other properties mentioned above, comprise:
(i) polyol component comprising, preferably in consisting essentially of, one or more polyols, preferably polyester polyols, having: (a) an average functionality of from about 2 to about 3; (b) an OH number (average) of from about 25 to about 30; and optionally but preferably an average molecular weight of from about 3000 to about 8000;
(ii) isocyanate component comprising, and preferably consisting essentially of, one or more MDI-based isocyanates with an NCO % of from about 18 to about 22, wherein the amount of said isocuyanate is preferably present in an amount relative to the polyol to provide an index of from about 90 to about 110;
(iii) blowing agent comprising (a) chemical blowing agent preferably comprising at least about 90% water; and (b) and physical blowing agent comprising from about 1 to about 15 php of one or more trifluoro,monochloropropenes (HFO-1233), preferably transHFO-1233zd.

Preferred foamable compositions of the present invention according to one embodiment, particularly including foamable compositions for forming integral skin foams having the preferred combinations of density, hardness and other properties mentioned above, comprise:
(i) polyol component comprising, preferably in consisting essentially of, one or more polyols, preferably polyester polyols, having: (a) an average functionality of from about 2 to about 4; (b) an OH number (average) of from about 20 to about 35; and optionally but preferably an average molecular weight of from about 3000 to about 8000;
(ii) isocyanate component comprising, and preferably consisting essentially of, one or more MDI-based isocyanates with an NCO % of from about 18 to about 24, wherein the amount of said isocuyanate is preferably present in an amount relative to the polyol to provide an index of from about 80 to about 120;
(iii) blowing agent comprising (a) chemical blowing agent preferably comprising at least about 90% water; and (b) and physical blowing agent comprising from about 3 to about 10 php of one or more trifluoro,monochloropropenes (HFO-1233), preferably transHFO-1233zd.

Preferred foamable compositions of the present invention according to one embodiment, particularly including foamable compositions for forming integral skin foams having the preferred combinations of density, hardness and other properties mentioned above, comprise:
(i) polyol component comprising, preferably in consisting essentially of, one or more polyols, preferably polyester polyols, having: (a) an average functionality of from about 2 to about 3; (b) an OH number (average) of from about 20 to about 35; and optionally but preferably an average molecular weight of from about 3000 to about 8000;
(ii) isocyanate component comprising, and preferably consisting essentially of, one or more MDI-based isocyanates with an NCO % of from about 18 to about 24, wherein the amount of said isocuyanate is preferably present in an amount relative to the polyol to provide an index of from about 80 to about 120;
(iii) blowing agent comprising (a) chemical blowing agent preferably comprising at least about 90% water; and (b) and physical blowing agent comprising from about 1 to about 15 php of one or more trifluoro,monochloropropenes (HFO-1233), preferably transHFO-1233zd.

Preferred foamable compositions of the present invention according to one embodiment, particularly including foamable compositions for forming integral skin foams having the preferred combinations of density, hardness and other properties mentioned above, comprise:
(i) polyol component comprising, preferably in consisting essentially of, one or more polyols, preferably polyester polyols, having: (a) an average functionality of from about 2 to about 4; (b) an OH number (average) of from about 25 to about 30; and optionally but preferably an average molecular weight of from about 3000 to about 8000;
(ii) isocyanate component comprising, and preferably consisting essentially of, one or more MDI-based isocyanates with an NCO % of from about 18 to about 24, wherein the amount of said isocuyanate is preferably present in an amount relative to the polyol to provide an index of from about 80 to about 120;
(iii) blowing agent comprising (a) chemical blowing agent preferably comprising at least about 90% water; and (b) and physical blowing agent comprising from about 3 to about 10 php, of one or more trifluoro,monochloropropenes (HFO-1233), preferably transHFO-1233zd.

Preferred foamable compositions of the present invention according to one embodiment, particularly including foamable compositions for forming integral skin foams having the preferred combinations of density, hardness and other properties mentioned above, comprise:
(i) polyol component comprising, preferably in consisting essentially of, one or more polyols, preferably polyester polyols, having: (a) an average functionality of from about 2 to about 3; (b) an OH number (average) of from about 25 to about 30; and optionally but preferably an average molecular weight of from about 3000 to about 8000;
(ii) isocyanate component comprising, and preferably consisting essentially of, one or more MDI-based isocyanates with an NCO % of from about 18 to about 24, wherein the amount of said isocuyanate is preferably present in an amount relative to the polyol to provide an index of from about 80 to about 120;
(iii) blowing agent comprising (a) chemical blowing agent preferably comprising at least about 90% water; and (b) and physical blowing agent comprising from about 1 to about 15 php of one or more trifluoro,monochloropropenes (HFO-1233), preferably transHFO-1233zd.
trans1233zd; polyester polyol FN 2-4; OH 20-35; ISO NCO-18-22 and INDEX 80-120; CHEM BA at least 90% water

Preferred foamable compositions of the present invention according to one embodiment, particularly including foamable compositions for forming integral skin foams having the preferred combinations of density, hardness and other properties mentioned above, comprise:
(i) polyol component comprising, preferably in consisting essentially of, one or more polyols, preferably polyester polyols, having: (a) an average functionality of from about 2 to about 4; (b) an OH number (average) of from about 20 to about 35; and optionally but preferably an average molecular weight of from about 3000 to about 8000;
(ii) isocyanate component comprising, and preferably consisting essentially of, one or more MDI-based isocyanates with an NCO % of from about 18 to about 22, wherein the amount of said isocuyanate is preferably present in an amount relative to the polyol to provide an index of from about 80 to about 120;
(iii) blowing agent comprising (a) chemical blowing agent preferably comprising at least about 90% water; and (b) and physical blowing agent comprising from about 3 to about 10 php of one or more trifluoro,monochloropropenes (HFO-1233), preferably transHFO-1233zd.

Preferred foamable compositions of the present invention according to one embodiment, particularly including foamable compositions for forming integral skin foams having the preferred combinations of density, hardness and other properties mentioned above, comprise:
(i) polyol component comprising, preferably in consisting essentially of, one or more polyols, preferably polyester polyols, having: (a) an average functionality of from about 2 to about 3; (b) an OH number (average) of from about 20 to about 35; and optionally but preferably an average molecular weight of from about 3000 to about 8000;
(ii) isocyanate component comprising, and preferably consisting essentially of, one or more MDI-based isocyanates with an NCO % of from about 18 to about 22, wherein the amount of said isocuyanate is preferably present in an amount relative to the polyol to provide an index of from about 80 to about 120;
(iii) blowing agent comprising (a) chemical blowing agent preferably comprising at least about 90% water; and (b) and physical blowing agent comprising from about 1 to about 15 php of one or more trifluoro,monochloropropenes (HFO-1233), preferably transHFO-1233zd.

Preferred foamable compositions of the present invention according to one embodiment, particularly including foamable compositions for forming integral skin foams having the preferred combinations of density, hardness and other properties mentioned above, comprise:
(i) polyol component comprising, preferably in consisting essentially of, one or more polyols, preferably polyester polyols, having: (a) an average functionality of from about 2 to about 4; (b) an OH number (average) of from about 25 to about 30; and optionally but preferably an average molecular weight of from about 3000 to about 8000;
(ii) isocyanate component comprising, and preferably consisting essentially of, one or more MDI-based isocyanates with an NCO % of from about 18 to about 22, wherein the amount of said isocuyanate is preferably present in an amount relative to the polyol to provide an index of from about 80 to about 120;
(iii) blowing agent comprising (a) chemical blowing agent preferably comprising at least about 90% water; and (b) and physical blowing agent comprising from about 3 to about 10 php of one or more trifluoro,monochloropropenes (HFO-1233), preferably transHFO-1233zd.

Preferred foamable compositions of the present invention according to one embodiment, particularly including foamable compositions for forming integral skin foams having the preferred combinations of density, hardness and other properties mentioned above, comprise:
(i) polyol component comprising, preferably in consisting essentially of, one or more polyols, preferably polyester polyols, having: (a) an average functionality of from about 2 to about 3; (b) an OH number (average) of from about 25 to about 30; and optionally but preferably an average molecular weight of from about 3000 to about 8000;
(ii) isocyanate component comprising, and preferably consisting essentially of, one or more MD I-based isocyanates with an NCO % of from about 18 to about 22, wherein the amount of said isocuyanate is preferably present in an amount relative to the polyol to provide an index of from about 80 to about 120;
(iii) blowing agent comprising (a) chemical blowing agent preferably comprising at least about 90% water; and (b) and physical blowing agent comprising from about 1 to about 15 php of one or more trifluoro,monochloropropenes (HFO-1233), preferably transHFO-1233zd.

Preferred foamable compositions of the present invention according to one embodiment, particularly including foamable compositions for forming integral skin foams having the preferred combinations of density, hardness and other properties mentioned above, comprise:
(i) polyol component comprising, preferably in consisting essentially of, one or more polyols, preferably polyester polyols, having: (a) an average functionality of from about 2 to about 4; (b) an OH number (average) of from about 20 to about 35; and optionally but preferably an average molecular weight of from about 3000 to about 8000;
(ii) isocyanate component comprising, and preferably consisting essentially of, one or more MDI-based isocyanates with an NCO % of from about 18 to about 24, wherein the amount of said isocuyanate is preferably present in an amount relative to the polyol to provide an index of from about 90 to about 110;
(iii) blowing agent comprising (a) chemical blowing agent preferably comprising at least about 90% water; and (b) and physical blowing agent comprising from about 3 to about 10 php of one or more trifluoro,monochloropropenes (HFO-1233), preferably transHFO-1233zd.

Preferred foamable compositions of the present invention according to one embodiment, particularly including foamable compositions for forming integral skin foams having the preferred combinations of density, hardness and other properties mentioned above, comprise:
(i) polyol component comprising, preferably in consisting essentially of, one or more polyols, preferably polyester polyols, having: (a) an average functionality of from about 2 to about 3; (b) an OH number (average) of from about 20 to about 35; and optionally but preferably an average molecular weight of from about 3000 to about 8000;
(ii) isocyanate component comprising, and preferably consisting essentially of, one or more MDI-based isocyanates with an NCO % of from about 18 to about 24, wherein the amount of said isocuyanate is preferably present in an amount relative to the polyol to provide an index of from about 90 to about 110;
(iii) blowing agent comprising (a) chemical blowing agent preferably comprising at least about 90% water; and (b) and physical blowing agent comprising from about 1 to about 15 php of one or more trifluoro,monochloropropenes (HFO-1233), preferably transHFO-1233zd.

Preferred foamable compositions of the present invention according to one embodiment, particularly including foamable compositions for forming integral skin foams having the preferred combinations of density, hardness and other properties mentioned above, comprise:
(i) polyol component comprising, preferably in consisting essentially of, one or more polyols, preferably polyester polyols, having: (a) an average functionality of from about 2 to about 4; (b) an OH number (average) of from about 25 to about 30; and optionally but preferably an average molecular weight of from about 3000 to about 8000;
(ii) isocyanate component comprising, and preferably consisting essentially of, one or more MDI-based isocyanates with an NCO % of from about 18 to about 24, wherein the amount of said isocuyanate is preferably present in an amount relative to the polyol to provide an index of from about 90 to about 110;
(iii) blowing agent comprising (a) chemical blowing agent preferably comprising at least about 90% water; and (b) and physical blowing agent comprising from about 3 to about 10 php of one or more trifluoro,monochloropropenes (HFO-1233), preferably transHFO-1233zd.

Preferred foamable compositions of the present invention according to one embodiment, particularly including foamable compositions for forming integral skin foams having the preferred combinations of density, hardness and other properties mentioned above, comprise:
(i) polyol component comprising, preferably in consisting essentially of, one or more polyols, preferably polyester polyols, having: (a) an average functionality of from about 2 to about 3; (b) an OH number (average) of from about 25 to about 30; and optionally but preferably an average molecular weight of from about 3000 to about 8000;
(ii) isocyanate component comprising, and preferably consisting essentially of, one or more MDI-based isocyanates with an NCO % of from about 18 to about 24, wherein the amount of said isocuyanate is preferably present in an amount relative to the polyol to provide an index of from about 90 to about 110;
(iii) blowing agent comprising (a) chemical blowing agent preferably comprising at least about 90% water; and (b) and physical blowing agent comprising from about 1 to about 15 php of one or more trifluoro,monochloropropenes (HFO-1233), preferably transHFO-1233zd.

Preferred foamable compositions of the present invention according to one embodiment, particularly including foamable compositions for forming integral skin foams having the preferred combinations of density, hardness and other properties mentioned above, comprise:
(i) polyol component comprising, preferably in consisting essentially of, one or more polyols, preferably polyester polyols, having: (a) an average functionality of from about 2 to about 4; (b) an OH number (average) of from about 20 to about 35; and optionally but preferably an average molecular weight of from about 3000 to about 8000;
(ii) isocyanate component comprising, and preferably consisting essentially of, one or more MDI-based isocyanates with an NCO % of from about 18 to about 22, wherein the amount of said isocuyanate is preferably present in an amount relative to the polyol to provide an index of from about 90 to about 110;
(iii) blowing agent comprising (a) chemical blowing agent preferably comprising at least about 90% water; and (b) and physical blowing agent comprising from about 3 to about 10 php of one or more trifluoro,monochloropropenes (HFO-1233), preferably transHFO-1233zd.

Preferred foamable compositions of the present invention according to one embodiment, particularly including foamable compositions for forming integral skin foams having the preferred combinations of density, hardness and other properties mentioned above, comprise:
(i) polyol component comprising, preferably in consisting essentially of, one or more polyols, preferably polyester polyols, having: (a) an average functionality of from about 2 to about 3; (b) an OH number (average) of from about 20 to about 35; and optionally but preferably an average molecular weight of from about 3000 to about 8000;
(ii) isocyanate component comprising, and preferably consisting essentially of, one or more MDI-based isocyanates with an NCO % of from about 18 to about 22, wherein the amount of said isocuyanate is preferably present in an amount relative to the polyol to provide an index of from about 90 to about 110;
(iii) blowing agent comprising (a) chemical blowing agent preferably comprising at least about 90% water; and (b) and physical blowing agent comprising from about 1 to about 15 php of one or more trifluoro,monochloropropenes (HFO-1233), preferably transHFO-1233zd.

Preferred foamable compositions of the present invention according to one embodiment, particularly including foamable compositions for forming integral skin foams having the preferred combinations of density, hardness and other properties mentioned above, comprise:
(i) polyol component comprising, preferably in consisting essentially of, one or more polyols, preferably polyester polyols, having: (a) an average functionality of from about 2 to about 4; (b) an OH number (average) of from about 25 to about 30; and optionally but preferably an average molecular weight of from about 3000 to about 8000;
(ii) isocyanate component comprising, and preferably consisting essentially of, one or more MDI-based isocyanates with an NCO % of from about 18 to about 22, wherein the amount of said isocuyanate is preferably present in an amount relative to the polyol to provide an index of from about 90 to about 110;
(iii) blowing agent comprising (a) chemical blowing agent preferably comprising at least about 90% water; and (b) and physical blowing agent comprising from about 3 to about 10 php of one or more trifluoro,monochloropropenes (HFO-1233), preferably transHFO-1233zd.

Preferred foamable compositions of the present invention according to one embodiment, particularly including foamable compositions for forming integral skin foams having the preferred combinations of density, hardness and other properties mentioned above, comprise:
(i) polyol component comprising, preferably in consisting essentially of, one or more polyols, preferably polyester polyols, having: (a) an average functionality of from about 2 to about 3; (b) an OH number (average) of from about 25 to about 30; and optionally but preferably an average molecular weight of from about 3000 to about 8000;
(ii) isocyanate component comprising, and preferably consisting essentially of, one or more MDI-based isocyanates with an NCO % of from about 18 to about 22, wherein the amount of said isocuyanate is preferably present in an amount relative to the polyol to provide an index of from about 90 to about 110;
(iii) blowing agent comprising (a) chemical blowing agent preferably comprising at least about 90% water; and (b) and physical blowing agent comprising from about 3 to about 10 php of one or more trifluoro,monochloropropenes (HFO-1233), preferably transHFO-1233zd.

Preferred foamable compositions of the present invention according to one embodiment, particularly including foamable compositions for forming integral skin foams having the preferred combinations of density, hardness and other properties mentioned above, comprise:
(i) polyol component comprising, preferably in consisting essentially of, one or more polyols, preferably polyester polyols, having: (a) an average functionality of from about 2 to about 4; (b) an OH number (average) of from about 20 to about 35; and optionally but preferably an average molecular weight of from about 3000 to about 8000;
(ii) isocyanate component comprising, and preferably consisting essentially of, one or more MDI-based isocyanates with an NCO % of from about 18 to about 24, wherein the amount of said isocuyanate is preferably present in an amount relative to the polyol to provide an index of from about 80 to about 120;
(iii) blowing agent comprising (a) chemical blowing agent preferably comprising at least about 90% water; and (b) and physical blowing agent comprising from about 5 to about 10 php of one or more trifluoro,monochloropropenes (HFO-1233), preferably transHFO-1233zd.

Preferred foamable compositions of the present invention according to one embodiment, particularly including foamable compositions for forming integral skin foams having the preferred combinations of density, hardness and other properties mentioned above, comprise:
(i) polyol component comprising, preferably in consisting essentially of, one or more polyols, preferably polyester polyols, having: (a) an average functionality of from about 2 to about 3; (b) an OH number (average) of from about 20 to about 35; and optionally but preferably an average molecular weight of from about 3000 to about 8000;
(ii) isocyanate component comprising, and preferably consisting essentially of, one or more MDI-based isocyanates with an NCO % of from about 18 to about 24, wherein the amount of said isocuyanate is preferably present in an amount relative to the polyol to provide an index of from about 80 to about 120;
(iii) blowing agent comprising (a) chemical blowing agent preferably comprising at least about 90% water; and (b) and physical blowing agent comprising from about 1 to about 15 php of one or more trifluoro,monochloropropenes (HFO-1233), preferably transHFO-1233zd.

Preferred foamable compositions of the present invention according to one embodiment, particularly including foamable compositions for forming integral skin foams having the preferred combinations of density, hardness and other properties mentioned above, comprise:
(i) polyol component comprising, preferably in consisting essentially of, one or more polyols, preferably polyester polyols, having: (a) an average functionality of from about 2 to about 4; (b) an OH number (average) of from about 25 to about 30; and optionally but preferably an average molecular weight of from about 3000 to about 8000;
(ii) isocyanate component comprising, and preferably consisting essentially of, one or more MDI-based isocyanates with an NCO % of from about 18 to about 24, wherein the amount of said isocuyanate is preferably present in an amount relative to the polyol to provide an index of from about 80 to about 120;
(iii) blowing agent comprising (a) chemical blowing agent preferably comprising at least about 90% water; and (b) and physical blowing agent comprising from about 5 to about 10 php, of one or more trifluoro,monochloropropenes (HFO-1233), preferably transHFO-1233zd.

Preferred foamable compositions of the present invention according to one embodiment, particularly including foamable compositions for forming integral skin foams having the preferred combinations of density, hardness and other properties mentioned above, comprise:
(i) polyol component comprising, preferably in consisting essentially of, one or more polyols, preferably polyester polyols, having: (a) an average functionality of from about 2 to about 3; (b) an OH number (average) of from about 25 to about 30; and optionally but preferably an average molecular weight of from about 3000 to about 8000;
(ii) isocyanate component comprising, and preferably consisting essentially of, one or more MDI-based isocyanates with an NCO % of from about 18 to about 24, wherein the amount of said isocuyanate is preferably present in an amount relative to the polyol to provide an index of from about 80 to about 120;
(iii) blowing agent comprising (a) chemical blowing agent preferably comprising at least about 90% water; and (b) and physical blowing agent comprising from about 1 to about 15 php of one or more trifluoro,monochloropropenes (HFO-1233), preferably transHFO-1233zd.

Preferred foamable compositions of the present invention according to one embodiment, particularly including foamable compositions for forming integral skin foams having the preferred combinations of density, hardness and other properties mentioned above, comprise:
(i) polyol component comprising, preferably in consisting essentially of, one or more polyols, preferably polyester polyols, having: (a) an average functionality of from about 2 to about 4; (b) an OH number (average) of from about 20 to about 35; and optionally but preferably an average molecular weight of from about 3000 to about 8000;
(ii) isocyanate component comprising, and preferably consisting essentially of, one or more MDI-based isocyanates with an NCO % of from about 18 to about 22, wherein the amount of said isocuyanate is preferably present in an amount relative to the polyol to provide an index of from about 80 to about 120;
(iii) blowing agent comprising (a) chemical blowing agent preferably comprising at least about 90% water; and (b) and physical blowing agent comprising from about 5 to about 10 php of one or more trifluoro,monochloropropenes (HFO-1233), preferably transHFO-1233zd.

Preferred foamable compositions of the present invention according to one embodiment, particularly including foamable compositions for forming integral skin foams having the preferred combinations of density, hardness and other properties mentioned above, comprise:
(i) polyol component comprising, preferably in consisting essentially of, one or more polyols, preferably polyester polyols, having: (a) an average functionality of from about 2 to about 3; (b) an OH number (average) of from about 20 to about 35; and optionally but preferably an average molecular weight of from about 3000 to about 8000;
(ii) isocyanate component comprising, and preferably consisting essentially of, one or more MDI-based isocyanates with an NCO % of from about 18 to about 22, wherein the amount of said isocuyanate is preferably present in an amount relative to the polyol to provide an index of from about 80 to about 120;
(iii) blowing agent comprising (a) chemical blowing agent preferably comprising at least about 90% water; and (b) and physical blowing agent comprising from about 1 to about 15 php of one or more trifluoro,monochloropropenes (HFO-1233), preferably transHFO-1233zd.

Preferred foamable compositions of the present invention according to one embodiment, particularly including foamable compositions for forming integral skin foams having the preferred combinations of density, hardness and other properties mentioned above, comprise:
(i) polyol component comprising, preferably in consisting essentially of, one or more polyols, preferably polyester polyols, having: (a) an average functionality of from about 2 to about 4; (b) an OH number (average) of from about 25 to about 30; and optionally but preferably an average molecular weight of from about 3000 to about 8000;
(ii) isocyanate component comprising, and preferably consisting essentially of, one or more MD I-based isocyanates with an NCO % of from about 18 to about 22, wherein the amount of said isocuyanate is preferably present in an amount relative to the polyol to provide an index of from about 80 to about 120;
(iii) blowing agent comprising (a) chemical blowing agent preferably comprising at least about 90% water; and (b) and physical blowing agent comprising from about 5 to about 10 php of one or more trifluoro,monochloropropenes (HFO-1233), preferably transHFO-1233zd.

Preferred foamable compositions of the present invention according to one embodiment, particularly including foamable compositions for forming integral skin foams having the preferred combinations of density, hardness and other properties mentioned above, comprise:
(i) polyol component comprising, preferably in consisting essentially of, one or more polyols, preferably polyester polyols, having: (a) an average functionality of from about 2 to about 3; (b) an OH number (average) of from about 25 to about 30; and optionally but preferably an average molecular weight of from about 3000 to about 8000;
(ii) isocyanate component comprising, and preferably consisting essentially of, one or more MDI-based isocyanates with an NCO % of from about 18 to about 22, wherein the amount of said isocuyanate is preferably present in an amount relative to the polyol to provide an index of from about 80 to about 120;
(iii) blowing agent comprising (a) chemical blowing agent preferably comprising at least about 90% water; and (b) and physical blowing agent comprising from about 1 to about 15 php of one or more trifluoro,monochloropropenes (HFO-1233), preferably transHFO-1233zd.

Preferred foamable compositions of the present invention according to one embodiment, particularly including foamable compositions for forming integral skin foams having the preferred combinations of density, hardness and other properties mentioned above, comprise:
(i) polyol component comprising, preferably in consisting essentially of, one or more polyols, preferably polyester polyols, having: (a) an average functionality of from about 2 to about 4; (b) an OH number (average) of from about 20 to about 35; and optionally but preferably an average molecular weight of from about 3000 to about 8000;
(ii) isocyanate component comprising, and preferably consisting essentially of, one or more MDI-based isocyanates with an NCO % of from about 18 to about 24, wherein the amount of said isocuyanate is preferably present in an amount relative to the polyol to provide an index of from about 90 to about 110;
(iii) blowing agent comprising (a) chemical blowing agent preferably comprising at least about 90% water; and (b) and physical blowing agent comprising from about 5 to about 10 php of one or more trifluoro,monochloropropenes (HFO-1233), preferably transHFO-1233zd.

Preferred foamable compositions of the present invention according to one embodiment, particularly including foamable compositions for forming integral skin foams having the preferred combinations of density, hardness and other properties mentioned above, comprise:
(i) polyol component comprising, preferably in consisting essentially of, one or more polyols, preferably polyester polyols, having: (a) an average functionality of from about 2 to about 3; (b) an OH number (average) of from about 20 to about 35; and optionally but preferably an average molecular weight of from about 3000 to about 8000;
(ii) isocyanate component comprising, and preferably consisting essentially of, one or more MDI-based isocyanates with an NCO % of from about 18 to about 24, wherein the amount of said isocuyanate is preferably present in an amount relative to the polyol to provide an index of from about 90 to about 110;
(iii) blowing agent comprising (a) chemical blowing agent preferably comprising at least about 90% water; and (b) and physical blowing agent comprising from about 1 to about 15 php of one or more trifluoro,monochloropropenes (HFO-1233), preferably transHFO-1233zd.

Preferred foamable compositions of the present invention according to one embodiment, particularly including foamable compositions for forming integral skin foams having the preferred combinations of density, hardness and other properties mentioned above, comprise:
(i) polyol component comprising, preferably in consisting essentially of, one or more polyols, preferably polyester polyols, having: (a) an average functionality of from about 2 to about 4; (b) an OH number (average) of from about 25 to about 30; and optionally but preferably an average molecular weight of from about 3000 to about 8000;
(ii) isocyanate component comprising, and preferably consisting essentially of, one or more MDI-based isocyanates with an NCO % of from about 18 to about 24, wherein the amount of said isocuyanate is preferably present in an amount relative to the polyol to provide an index of from about 90 to about 110;
(iii) blowing agent comprising (a) chemical blowing agent preferably comprising at least about 90% water; and (b) and physical blowing agent comprising from about 5 to about 10 php of one or more trifluoro,monochloropropenes (HFO-1233), preferably transHFO-1233zd.

Preferred foamable compositions of the present invention according to one embodiment, particularly including foamable compositions for forming integral skin foams having the preferred combinations of density, hardness and other properties mentioned above, comprise:
(i) polyol component comprising, preferably in consisting essentially of, one or more polyols, preferably polyester polyols, having: (a) an average functionality of from about 2 to about 3; (b) an OH number (average) of from about 25 to about 30; and optionally but preferably an average molecular weight of from about 3000 to about 8000;
(ii) isocyanate component comprising, and preferably consisting essentially of, one or more MDI-based isocyanates with an NCO % of from about 18 to about 24, wherein the amount of said isocuyanate is preferably present in an amount relative to the polyol to provide an index of from about 90 to about 110;
(iii) blowing agent comprising (a) chemical blowing agent preferably comprising at least about 90% water; and (b) and physical blowing agent comprising from about 1 to about 15 php of one or more trifluoro,monochloropropenes (HFO-1233), preferably transHFO-1233zd.

Preferred foamable compositions of the present invention according to one embodiment, particularly including foamable compositions for forming integral skin foams having the preferred combinations of density, hardness and other properties mentioned above, comprise:
(i) polyol component comprising, preferably in consisting essentially of, one or more polyols, preferably polyester polyols, having: (a) an average functionality of from about 2 to about 4; (b) an OH number (average) of from about 20 to about 35; and optionally but preferably an average molecular weight of from about 3000 to about 8000;
(ii) isocyanate component comprising, and preferably consisting essentially of, one or more MDI-based isocyanates with an NCO % of from about 18 to about 22, wherein the amount of said isocuyanate is preferably present in an amount relative to the polyol to provide an index of from about 90 to about 110;
(iii) blowing agent comprising (a) chemical blowing agent preferably comprising at least about 90% water; and (b) and physical blowing agent comprising from about 5 to about 10 php of one or more trifluoro,monochloropropenes (HFO-1233), preferably transHFO-1233zd.

Preferred foamable compositions of the present invention according to one embodiment, particularly including foamable compositions for forming integral skin foams having the preferred combinations of density, hardness and other properties mentioned above, comprise:
(i) polyol component comprising, preferably in consisting essentially of, one or more polyols, preferably polyester polyols, having: (a) an average functionality of from about 2 to about 3; (b) an OH number (average) of from about 20 to about 35; and optionally but preferably an average molecular weight of from about 3000 to about 8000;
(ii) isocyanate component comprising, and preferably consisting essentially of, one or more MDI-based isocyanates with an NCO % of from about 18 to about 22, wherein the amount of said isocuyanate is preferably present in an amount relative to the polyol to provide an index of from about 90 to about 110;
(iii) blowing agent comprising (a) chemical blowing agent preferably comprising at least about 90% water; and (b) and physical blowing agent comprising from about 1 to about 15 php of one or more trifluoro,monochloropropenes (HFO-1233), preferably transHFO-1233zd.

Preferred foamable compositions of the present invention according to one embodiment, particularly including foamable compositions for forming integral skin foams having the preferred combinations of density, hardness and other properties mentioned above, comprise:
(i) polyol component comprising, preferably in consisting essentially of, one or more polyols, preferably polyester polyols, having: (a) an average functionality of from about 2 to about 4; (b) an OH number (average) of from about 25 to about 30; and optionally but preferably an average molecular weight of from about 3000 to about 8000;
(ii) isocyanate component comprising, and preferably consisting essentially of, one or more MDI-based isocyanates with an NCO % of from about 18 to about 22, wherein the amount of said isocuyanate is preferably present in an amount relative to the polyol to provide an index of from about 90 to about 110;
(iii) blowing agent comprising (a) chemical blowing agent preferably comprising at least about 90% water; and (b) and physical blowing agent comprising from about 5 to about 10 php of one or more trifluoro,monochloropropenes (HFO-1233), preferably transHFO-1233zd.

Preferred foamable compositions of the present invention according to one embodiment, particularly including foamable compositions for forming integral skin foams having the preferred combinations of density, hardness and other properties mentioned above, comprise:
(i) polyol component comprising, preferably in consisting essentially of, one or more polyols, preferably polyester polyols, having: (a) an average functionality of from about 2 to about 3; (b) an OH number (average) of from about 25 to about 30; and optionally but preferably an average molecular weight of from about 3000 to about 8000;
(ii) isocyanate component comprising, and preferably consisting essentially of, one or more MDI-based isocyanates with an NCO % of from about 18 to about 22, wherein the amount of said isocuyanate is preferably present in an amount relative to the polyol to provide an index of from about 90 to about 110;
(iii) blowing agent comprising (a) chemical blowing agent preferably comprising at least about 90% water; and (b) and physical blowing agent comprising from about 3 to about 10 php of one or more trifluoro,monochloropropenes (HFO-1233), preferably transHFO-1233zd.

2. ISF and Shoe Sole Foams With HF01234 Blowing Agent

Each of the preferred foamable compositions identified in the preceding section 1 can be altered by replacing the physical blowing agent described in each formulation with a physical blowing agent comprising, preferably in major proportion by weight, of one or more tetrafluoropropenes (HFO-1234), preferably transHFO-1234ze, HFO-1234yf and combinations of these.

3. ISF and Shoe Sole Foams With HF01336 Blowing Agent

Each of the preferred foamable compositions identified in the preceding section 1 can be altered by replacing the physical blowing agent described in each formulation with a physical blowing agent comprising, preferably in major proportion by weight, of one or more hexafluorbutenes(HFO-1336), preferably HFO-1336mmz(Z).

### Methods and Systems

It is contemplated that all presently known and available methods and systems for forming foam, particularly integral skin foams, are readily adaptable for use in connection with the present invention. For example, the methods of the present invention generally require incorporating a blowing agent in accordance with the present invention into a foamable or foam forming composition and then foaming the composition, preferably by a step or series of steps which include causing volumetric expansion of the blowing agent in accordance with the present invention. In general, it is contemplated that the presently used systems and devices for incorporation of blowing agent and for foaming are readily adaptable for use in accordance with the present invention. In fact, it is believed that one advantage of the present invention is the provision of an improved blowing agent which is generally compatible with existing foaming methods and systems while similarly minimizes foam premix instability.

Thus, it will be appreciated by those skilled in the art that the present invention comprises methods and systems for foaming all types of foams, but particularly semi-rigid foams, and even more particularly integral skin foams including those used in shoe soles. Thus, one aspect of the present invention is the use of the present blowing agents in connection conventional foaming equipment, particularly for integral skin foam production, such as polyurethane foaming equipment, at conventional processing conditions. The present methods therefore include masterbatch type operations, blending type operations, third stream blowing agent addition, and blowing agent addition at the foam head.

It will be appreciated by those skilled in the art, especially in view of the disclosure contained herein, that the order and manner in which the blowing agent of the present invention is formed and/or added to the foamable composition does not generally affect the operability of the present invention. Moreover, the blowing agent can be introduced either directly or as part of a premix, which is then further added to other parts of the foamable composition.

In certain embodiments, two or more components of the blowing agent are combined in advance and introduced together into the foamable composition, either directly or as part of premix which is then further added to other parts of the foamable composition.

One embodiment of the present invention relates to methods of forming an integral skin foams, and preferably polyurethane foams. The methods generally comprise providing a blowing agent composition of the present inventions, adding (directly or indirectly) the blowing agent composition to a foamable composition, and reacting the foamable composition under the conditions effective to form a foam or cellular structure, as is well known in the art. Any of the methods well known in the art, such as those described in “Polyurethanes Chemistry and Technology,” Volumes I and II, Saunders and Frisch, 1962, John Wiley and Sons, New York, N.Y., which is incorporated herein by reference, may be used or adapted for use in accordance with the foam embodiments of the present invention. In general, such preferred methods comprise preparing polyurethane foam by combining an isocyanate, a polyol or mixture of polyols, a blowing agent or mixture of blowing agents comprising one or more of the present compositions, and other materials such as catalysts, surfactants, and optionally, flame retardants, colorants, or other additives. With regard to integral skin foams, in certain aspects, the combination of ingredients may be provided to a mold (such as but not limited to injection molding), where the foam is formed to a particular shape, size and configuration based on the features of the mold. Such a mold may, for example, be for an aspect or some portion of a shoe sole. An example of a shoe sole mold and molding operation is illustrated and described in US Application 2004/0094864, which is incorporated herein in its entirety, and such molding operations and other similar operations known to those skilled in the art can be used according to the present invention. An example of an automotive head rest mold and molding operation is illustrated and described in U.S. Pat. No. 7,28,973, which is incorporated herein in its entirety, and such molding operations and other similar operations known to those skilled in the art can be used according to the present invention.

It is convenient in many applications to provide the components for polyurethane foams in pre-blended formulations. Most typically, the foam formulation is pre-blended into two components. The isocyanate and optionally certain surfactants and blowing agents comprise the first component, sometimes referred to as the ISO component. The polyol or polyol mixture, surfactant, catalysts, blowing agents, flame retardant, and other isocyanate reactive components comprise the second component, sometimes referred to as the POLYOL component or “polyol premix.” Accordingly, polyurethane foam is readily prepared by bringing together the ISO and the POLYOL components either by hand mix for small preparations and, preferably, machine mix techniques. Optionally, other ingredients such as stabilizers, chain extenders, fire retardants, colorants, auxiliary blowing agents, and even other polyols can be added as one or more additional streams to the mix head or reaction site. Most preferably, however, they are all incorporated into one POLYOL component as described above. It is contemplated also that in certain embodiments it may be desirable to utilize the present compositions when in the supercritical or near supercritical state as a blowing agent.

In certain non-limiting embodiments, the foams of this invention may be manufactured by generally introducing the isocyanate side and resin side into a mold, or two sides or components can be brought together an thouroughly mixed just prior to being introduced into the mold. During the foam molding process, it is generally preferred that the internal pressure inside the mold could be as high as 1.5MPa and as a result the boiling point of the blowing agent will increase. This blowing agent in the skin part (in contact with cold mold surface) will condense to liquid from a gas phase due to the increased boiling point resulted from increased pressure inside the mold and consequently the solid non cellular (or potentially microcellular) skin having a thickness for from about 1 mm to about 5 mm forms. It will be appreciated that the mechanical parameters of the instant process are flexible and may depend on the final application of the integral skin polyurethane foam. The low boiing point blowing agent can be blended with polyol, or blended with isocyanate. The blowing agent can also be added via third stream. The polyurethane composition as disclosed herein is preferably versatile enough that it may be made in a variety of densities and hardnesses. The foam can be made by either preheated closed mold or by a hard pressure injection technique. In this manner, the composition process is well enough to fill complex molds at low mold densities. The composition may also be run using a conventional open mold technique when the reaction mixture or system is poured or injected at low pressure or atmospheric pressure into the preheated open mold. In such processes, the composition may be run at mold temperatures from about room temperature to about 50° C., preferably from about 30° C. to about 50° C.

The integral skin polyeurethene foam articles resulting from the present invention are generally characterized by a surprisingly advantageous mix of physical performance properties. In particular, polyeurethene foam articles made according to the invention are specially suited for use as shoe soles.

In preferred embodiments, the integral skin polyeurethene molded articles of the invention are characterized by a tensile strength of greater than or equal to 450 psi. In addition to tensile strength, taber abrasion (mg loss) is a particularly important property in certain applications, including several embodiments in which the integral skin polyurethane foam is used in shoe soles. In particular, such foams should have a taber abrasion (mg loss) of less than 200. Other important properties with respect to the foams of the invention are rebounding, compression set, energy absorption,impact resistance, compression resistance, elongation, tear strength, shore hardness, and ross flex.

### The Foams

The invention also relates to all foams, but in particular to semi-rigid foams, and even more particularly to integral skin foams and the like, prepared from a polymer foam formulation containing a blowing agent comprising the compositions of the invention. Applicants have found that one advantage of the foams, and particularly integral skin foams such as polyurethane foams, in accordance with the present invention is the ability to achieve, preferably in connection with such foam embodiments exceptional abrasion resistance. Applicants have further found the ability to achieve storage stability of such foams, in that degradative reactivity between the components (e.g. the catalysts and blowing agents) is minimized, if not eliminated. Although it is contemplated that the present foams may be used in a wide variety of applications, in certain preferred embodiments the present invention comprises integral skin foams used to produce shoe soles.

The foams in accordance with the present invention, in certain preferred embodiments, provide one or more exceptional features, characteristics and/or properties, including: dimensional stability, compressive strength, aging of foam properties, hydrolytic stability, rebounding, low temperature flexibility, storage stability of the premix formulations, all in addition to the low ozone depletion potential and low global warming potential associated with many of the preferred blowing agents of the present invention. In certain highly preferred embodiments, the present invention provides integral skin foam, including such foam formed into foam articles (e.g. shoe soles), which exhibit improved abrasion resistance, hydrolytic stability, rebounding, compression set, and/or low temperature flexibility relative to foams made using the same blowing agent (or a commonly used blowing agent HFC-245fa) in the same amount but without the compound of Formula I in accordance with the present invention.

In other preferred embodiments, the present foams exhibit improved mechanical properties relative to foams produced with blowing agents outside the scope of the present invention. For example, certain preferred embodiments of the present invention provide foams and foam articles having a compressive strength which is superior to, and preferably at least about 10 relative percent, and even more preferably at least about 15 relative percent greater than a foam produced under substantially identical conditions by utilizing a blowing agent consisting of cyclopentane. Furthermore, it is preferred in certain embodiments that the foams produced in accordance with the present invention have compressive strengths that are on a commercial basis comparable to the compressive strength produced by making a foam under substantially the same conditions except wherein the blowing agent consists of HFC-245fa. In certain preferred embodiments, the foams of the present invention exhibit a compressive strength of at least about 12.5% yield (in the parallel and perpendicular directions), and even more preferably at least about 13% yield in each of said directions.

### EXAMPLES

The following examples are provided for the purpose of illustrating the present invention but without limiting the scope thereof.

### Comparative Example A

### Water and Cyclopentane Blowing Agent in Integral Skin Foam

A polyol premix formulation is made up of 100 parts by weight of a polyol blend, 7 parts per hundred parts of polyol by weight (hereinafter referred to as “pphp”) of chain extender 1,4-butanediol, 0.3 pphp of silicone surfactant, 0.2 pphp chemical blowing agent weight water, 1 pphp 1,2-dimethylimidazole (sold as Toyocat DM 70 by Tosoh Corp.) catalyst; 0.05 pphp of tin metal catalyst (sold as Dabco T120 by Air Products) and 4.3 parts by weight cyclopentane physical blowing agent. The polyol mixture consisted of 60 parts by weight of Poly L-255-28, 20 pbw of Pluracol 5132 and 20 pbw of Poly G-85-29. The total B component composition is then mixed with 57.4 parts by weight of Rubinate 1209 isocyanate and placed into a mold to form integral skin foam having the following properties in Table EC1 (each value being understood as being modified by “about”):

TABLE CEA

| | |
|---|---|
| Density (pcf) | 25 |
| Shore A Hardness | 56 |

This test indicates that the use of cyclopentane and water in combination produces an unacceptably high density value (substantially above the preferred values of 20, 15 and 10 pcf), especially when compared to the density produced when water is the sole blowing agent.

### Comparative Example B

### Water and Methylal Blowing Agent in Integral Skin Foam

Comparative Example A is repeatred except 4.7 parts by weight methylal physical blowing agent is used in place of cyclopentane to provide the same number of moles as cyclopentane. The total polyol premix formulation is then mixed with 57.4 parts by weight of Rubinate 1209 isocyanate and placed into a mold to form an integral skin foam having the following properties in Table CEB (each value being understood as being modified by “about”):

TABLE CEB

| | |
|---|---|
| Density (pcf) | 26 |
| Shore A Hardness | 48 |

This test indicates that the use of methylal and water in combination produces an unacceptably high density value (substantially above the preferred values of 20, 15 and 10 pcf), especially when compared to the density produced when water is the sole blowing agent.

### Comparative Example C

### Water and Methylformate Blowing Agent in Integral Skin Foam

Comparative Example A is repeatred except 3.7 parts by weight methylformate physical blowing agent is used in place of cyclopentane to produce the same number of moles as cyclopentane. The total polyol premix composition is then mixed with 57.4 parts by weight of Rubinate 1209 isocyanate and placed into a mold to form integral skin foam having the following properties in Table CEC (each value being understood as being modified by “about”):

TABLE CEC

| | |
|---|---|
| Density (pcf) | 21 |
| Shore A Hardness | 45 |

This test indicates that the use of methylal and water in combination produces an unacceptably high density value (substantially above the preferred values of 20, 15 and 10 pcf), especially when compared to the density produced when water is the sole blowing agent.

### Comparative Example D

### Water and HFC-245fa Blowing Agent in Integral Skin Foam

Comparative Example A is repeatred except 8.2 parts by weight 1,1,1,3,3-pentafluoropropane (HFC-245fa) physical blowing agent is used in place of cyclopentane to produce the same number of moles as cyclopentane. The total polyol premix formulation is then mixed with 57.4 parts by weight of Rubinate 1209 isocyanate and placed into a mold to form an integral skin foam having the following properties in Table CED (each value being understood as being modified by “about”):

TABLE CED

| | |
|---|---|
| Density (pcf) | 7 |
| Shore A Hardness | 29 |

This test indicates that the use of 1,1,1,3,3-pentafluoropropane (HFC-245fa) and water in combination produces an unacceptably low Shore A hardness (below the preferred values of greater than 30 and substantially below the preferred values of greater than 35, 40 and 45).

### Example 1A

### Water and HCFO-1233zd(E) Blowing Agent in Integral Skin Foam

The procedure of Comparative Example A is repeatred except 8 parts by weight HCFO-1233zd(E) physical blowing agent is used in stead of cyclopentane to provide the same number of moles as cyclopentane. The total polyol premix formulation is then mixed with 57.4 parts by weight of Rubinate 1209 isocyanate and placed into a mold to form an integral skin foam having the following properties in Table 1 (each value being understood as being modified by “about”):

TABLE 1

| | |
|---|---|
| Density (pcf) | 13 |
| Shore A Hardness | 50 |

This test shows the unexpected by highly desirable ability of foamable compositions of the present invention to produce at once low and desirable core densities in the integral skin foam and high and desirable Shore A hardness values in the skin.

### Example 1B

### Water and HFO-1234yf Blowing Agent in Integral Skin Foam

Example 1A is repeated except that the physical blowing agent is replaced on a mole for mole basis with 1234yf. An integral skin foam is formed.

### Example 1C

### Water and TransHFO-1234ze Blowing Agent in Integral Skin Foam

Example 1A is repeated except that the physical blowing agent is replaced on a mole for mole basis with transHFO-1234ze. An integral skin foam is formed.

### Example 2

### Water and HCFO-1233xf Blowing Agent in Integral Skin Foam

The procedure of Comparative Example A is repeated except 8 parts by weight HCFC-1233xf physical blowing agent is used in stead of cyclopentane to provide the same number of moles as cyclopentane. The total polyol premix formulation is then mixed with 57.4 parts by weight of Rubinate 1209 isocyanate and placed into a mold to form an integral skin foam having the following properties in Table 2 (each value being understood as being modified by “about”):

TABLE 2

| | |
|---|---|
| Density (pcf) | 10 |
| Shore A Hardness | 39 |

This test shows the unexpected by highly desirable ability of foamable compositions of the present invention to produce at once low and desirable core densities in the integral skin foam and high and desirable Shore A hardness values in the skin.

### Example 3

### Water and HFO-1336 Blowing Agent in Integral Skin Foam

The procedure of Comparative Example A is repeated except 10.1 parts by weight CIS1,1,1,4,4,4-hexafluoropropene (HFO-1336mzz(Z)) physical blowing agent is used in stead of cyclopentane to provide the same number of moles as cyclopentane. The total polyol premix formulation is then mixed with 57.4 parts by weight of Rubinate 1209 isocyanate and placed into a mold to form an integral skin foam having the following properties in Table 3 (each value being understood as being modified by “about”):

TABLE 3

| | |
|---|---|
| Density (pcf) | 12 |
| Shore A | 38 |
| Hardness | |

This test shows the unexpected by highly desirable ability of foamable compositions of the present invention to produce at once low and desirable core densities in the integral skin foam and high and desirable Shore A hardness values in the skin.

### Example 4A

### Water, HFO-1233zd(E) and Cyclopentane Blowing Agent in Integral Skin Foam

The procedure of Comparative Example A is repeated except a mixture of HFO-1233zd(E):cyclopentane in an 80:20 molar ratio is used in an amount to provide the same number of total moles of cyclopentane as in Comparative Example A. The total polyol premix formulation is then mixed with 57.4 parts by weight of Rubinate 1209 isocyanate and placed into a mold to form an integral skin foam having the following properties in Table 4 (each value being understood as being modified by “about”):

TABLE 4

| | |
|---|---|
| Density (pcf) | 9 |
| Shore A | 41 |
| Hardness | |

This test shows the unexpected by highly desirable ability of foamable compositions of the present invention to produce at once low and desirable core densities in the integral skin foam and high and desirable Shore A hardness values in the skin.

### Example 4B

### Water and HFO-1234yf Blowing Agent in Integral Skin Foam

Example 4A is repeated except that the 1233zd component of the physical blowing agent is replaced on a mole for mole basis with 1234yf. An integral skin foam is formed.

### Example 4C

### Water and TransHFO-1234ze Blowing Agent in Integral Skin Foam

Example 4A is repeated except that the 1233zd component physical blowing agent is replaced on a mole for mole basis with transHFO-1234ze. An integral skin foam is formed.

### Example 4D

### Water and HFO-1233xf Blowing Agent in Integral Skin Foam

Example 4A is repeated except that the 1233zd component physical blowing agent is replaced on a mole for mole basis with HFO-1233xf. An integral skin foam is formed.

### Example 4E

### Water and HFO-1336mmz Blowing Agent in Integral Skin Foam

Example 4A is repeated except that the 1233zd component physical blowing agent is replaced on a mole for mole basis with HFO-1336mmz. An integral skin foam is formed.

### Example 5A

### Water, HFO-1233zd(E) and Methylformate Blowing Agent in Integral Skin Foam

The procedure of Comparative Example A is repeated except a mixture of HFO-1233zd(E):methylformate in an 80:20 molar ratio is used in an amount to provide the same number of total moles of cyclopentane as in Comparative Example A. The total polyol premix formulation is then mixed with 57.4 parts by weight of Rubinate 1209 isocyanate and placed into a mold to form an integral skin foam having the following properties in Table 5 (each value being understood as being modified by “about”):

TABLE 5

| | |
|---|---|
| Density (pcf) | 9 |
| Shore A | 36 |
| Hardness | |

This test shows the unexpected by highly desirable ability of foamable compositions of the present invention to produce at once low and desirable core densities in the integral skin foam and high and desirable Shore A hardness values in the skin.

### Example 5B

### Water, Methylformate and HFO-1234yf Blowing Agent in Integral Skin Foam

Example 5A is repeated except that the 1233zd component of the physical blowing agent is replaced on a mole for mole basis with 1234yf. An integral skin foam is formed.

### Example 5C

### Water, Methylformate and transHFO-1234ze Blowing Agent in Integral Skin Foam

Example 5A is repeated except that the 1233zd component physical blowing agent is replaced on a mole for mole basis with transHFO-1234ze. An integral skin foam is formed.

### Example 5D

### Water, Methylformate and HFO-1233xf Blowing Agent in Integral Skin Foam

Example 5A is repeated except that the 1233zd component of the physical blowing agent is replaced on a mole for mole basis with HFO-1233xf. An integral skin foam is formed.

### Example 5E

### Water, Methylformate and HFO-1336mmz BLOWING Agent in Integral Skin Foam

Example 5A is repeated except that the 1233zd component physical blowing agent is replaced on a mole for mole basis with HFO-1336mmz. An integral skin foam is formed.

### Example 6A

### Water, HFO-11233zd(E) and Methyal Blowing Agent in Integral Skin Foam

The procedure of Comparative Example A is repeated except a mixture of HFO-1233zd(E):methylal in an 80:20 molar ratio is used in an amount to provide the same number of total moles of cyclopentane as in Comparative Example A. The total polyol premix formulation is then mixed with 57.4 parts by weight of Rubinate 1209 isocyanate and placed into a mold to form an integral skin foam having the following properties in Table 6 (each value being understood as being modified by “about”):

TABLE 6

| | |
|---|---|
| Density (pcf) | 10 |
| Shore A | 44 |
| Hardness | |

This test shows the unexpected by highly desirable ability of foamable compositions of the present invention to produce at once low and desirable core densities in the integral skin foam and high and desirable Shore A hardness values in the skin.

### Example 6B

### Water, Methhyal and HFO-1234yf Blowing Agent in Integral Skin Foam

Example 6A is repeated except that the 1233zd component of the physical blowing agent is replaced on a mole for mole basis with 1234yf. An integral skin foam is formed.

### Example 6C

### Water, Methyal and transHFO-1234ze Blowing Agent in Integral Skin Foam

Example 6A is repeated except that the 1233zd component physical blowing agent is replaced on a mole for mole basis with transHFO-1234ze. An integral skin foam is formed.

### Example 6D

### Water, Methyal and HFO-1233xf Blowing Agent in Integral Skin Foam

Example 6A is repeated except that the 1233zd component of the physical blowing agent is replaced on a mole for mole basis with HFO-1233xf. An integral skin foam is formed.

### Example 6E

### Water, Methyal and HFO-1336mmz Blowing Agent in Integral Skin Foam

Example 6A is repeated except that the 1233zd component physical blowing agent is replaced on a mole for mole basis with HFO-1336mmz. An integral skin foam is formed.

### Example 7A

### Water, HFO-1233zd(E) and HFC-245fa Blowing Agent in Integral Skin Foam

The procedure of Comparative Example A is repeated except a mixture of HFO-1233zd(E):HFC-245fa in an 80:20 molar ratio is used in an amount to provide the same number of total moles of cyclopentane as in Comparative Example A. The total polyol premix formulation is then mixed with 57.4 parts by weight of Rubinate 1209 isocyanate and placed into a mold to form an integral skin foam having the following properties in Table 7 (each value being understood as being modified by “about”):

TABLE 7

| | |
|---|---|
| Density (pcf) | 8 |
| Shore A | 34 |
| Hardness | |

This test shows the unexpected by highly desirable ability of foamable compositions of the present invention to produce at once low and desirable core densities in the integral skin foam and high and desirable Shore A hardness values in the skin.

### Example 7B

### Water, HFC-245fa and HFO-1234yf Blowing Agent in Integral Skin Foam

Example 7A is repeated except that the 1233zd component of the physical blowing agent is replaced on a mole for mole basis with 1234yf. An integral skin foam is formed.

### Example 7C

### Water, HFC-245fa and TransHFO-1234ze Blowing Agent in Integral Skin Foam

Example 7A is repeated except that the 1233zd component physical blowing agent is replaced on a mole for mole basis with transHFO-1234ze. An integral skin foam is formed.

### Example 7D

### Water, HFC-245fa and HFO-1233xf Blowing Agent in Integral Skin Foam

Example 7A is repeated except that the 1233zd component of the physical blowing agent is replaced on a mole for mole basis with HFO-1233xf. An integral skin foam is formed.

### Example 7E

### Water, HFC-245fa and HFO-1336mmz Blowing Agent in Integral Skin Foam

Example 7A is repeated except that the 1233zd component physical blowing agent is replaced on a mole for mole basis with HFO-1336mmz. An integral skin foam is formed.

### Examples 8A-8G

### Water and HFO-1233ZD(E) Blowing Agent in Shoe Sole

A polyol premix is made up of 90 parts by weight of Diexter 1100-56 polyol, 8 pbw of ethylene glycol polyol, 0.8 pbw of silicone surfactant B8948, 0.8 pbw chemical blowing agent water, 0.6 pbw 1,2-dimethylimidazole (sold as Toyocat DM 70 by Tosoh Corp.) catalyst; 0.05 pphp of a reactive amine catalyst sold as Polycat 204 by AirProducts and HFO-1233zd(E) in a series of different amounts to produce a variety of core densities as indicated in Table 9 below. For each B component, the total B component composition is then mixed with 57.4 parts by weight of Suprasec 9612 isocyanate and placed into a mold to form an integral skin foam suitable for use in shoe sole applications. The integral skin foams thus formed had the properties as indicted below in Table 8 (each value being understood as being modified by “about”):

TABLE 8

| Example No. | 8A | 8B | 8C | 8D | 9E | 8F | 8G |
|---|---|---|---|---|---|---|---|
| Density (pcf) | 17.8 | 18.4 | 18.7 | 19.1 | 19.7 | 20.7 | 31.8 |
| Shore C Hardness | 76 | 76 | 78 | 77 | 77 | 80 | 83 |

The rebounding percentage of Example 8A was 29.3. These results show the unexpected advantage in the hardness that is achieved in the skin layer as the density of the foam is decreased to values of below about 20 pcf. More specifically, applicants have unexpectedly found that the decrease in skin hardness which occurs as the density of the foam is decreased from about 32 pcf to 20 pcf is substantially not present in the density range of from about 18.5 to about 20 pcf and is a much lower average rate of hardness decrease overall below a core density of 20 pcf, wherein said decrease in core density results from increasing amounts of HFO-1233zd(E) in the blowing agent. This result is unexpected and highly advantageous.

### Example 8H

### Water and HFO-1234yf Blowing Agent in Shoe Sole Foam

Example 8A is repeated except that the 1233zd component of the physical blowing agent is replaced on a mole for mole basis with 1234yf. An integral skin foam is formed.

### Example 8I

### Water and TransHFO-1234ze Blowing Agent in Shoe Sole Foam

Example 8A is repeated except that the 1233zd component physical blowing agent is replaced on a mole for mole basis with transHFO-1234ze. An integral skin foam is formed.

### Example 8J

### Water and HFO-1233xf Blowing Agent in Shoe Sole Foam

Example 8A is repeated except that the 1233zd component of the physical blowing agent is replaced on a mole for mole basis with HFO-1233xf. An integral skin foam is formed.

### Example 8K

### Water and HFO-1336mmz Blowing Agent in Integral Skin Foam

Example 8A is repeated except that the 1233zd component physical blowing agent is replaced on a mole for mole basis with HFO-1336mmz. An integral skin foam is formed.

### Comparative Example D

### Water as Blowing Agent in for Mid-Sole Shoe Sole Integral Skin Foam

A polyol premix formulation is made up of: 100 parts by weight of a polyol blend; 9 parts per hundred parts of polyol by weight (hereinafter referred to as “php”) of chain extender consisting of monoethylene glycol; 4 php of antistatic agent Verstate AC/N; 1 php of triethanolamine crosslinking agent; 1.5 php of catalyst (33% triethyleneamine in ethylene glycol sold by AirProducts as DABCO 33EG; 0.95 php water as chemical blowing agent. The polyol blend consisted of 80 parts by weight of HDR V4 and 20 pbw of PE016. The ISO component consisted of ISN 26 in an amount to provide an Index of 100 (105 php). The POLYOL component (maintained at 35° C.) and the ISO component (maintained at 50° C.) are then introduced to a low pressure pouring machine made by PU MIX srl with an output of 40 g/s. A mixing speed of 7000 rpm was used to prepare shoe sole sample for physical property testing. The test plate was made in an aluminum mold at 50° C. for each of two different sizes: 18×12×2 cm (used for compression set determination) and 18×25×1 cm (used for all other tests). The shoe sole test plates thus formed are tested (18×12×2 cm is used for compression set determination and the 18×25×1 cm is used for all other tests) and found to have the following properties in Table CED (each value being understood as being modified by “about”):

TABLE CED

| | |
|---|---|
| Density (pcf) | 20.6 |
| Shore A | 42-44 |
| Hardness | |
| Elongation | 900 |
| Tensile | 3.2 |
| Strength | |
| Tear Strength | 15.5 |
| Compression | 17.7 |
| st (25%, 22 | |
| hours, 70 C.) | |
| Rebound (DIN | 15-16 |
| 53512) | |

### Example 9A

### Water Plus 1233ZD(E)AS Blowing Agent in for Mid-Sole Shoe Sole Integral Skin Foam

Comparative Example D is repeated except that the ISO component was modified to include 2% (i.e., 2 php) of HFO-1233zd(E) and the amount of water was reduced to 0.7 php, and the amount of foamable composition was increased to overpack the mold to achieve the same density as produced in Comparative Example D. The shoe sole test plates thus formed are tested as in Comparative Example D and found to have the following properties in Table 9, with the values from Table CED being repeated for convenience (each value being understood as being modified by “about”):

TABLE 9

| Example>> | | | |
|---|---|---|---|
| Property | Comparative | Example | Improvement |
| ▾ ▾ | Example D | 9 | (%) |
| Density (pcf) | 20.6 | 20.6 | |
| Shore A | 42-44 | 42-44 | 0 |
| Hardness | | | |
| Elongation | 900 | 910 | 1.1 |
| Tensile Strength | 3.2 | 3.2 | 0 |
| Tear Strength | 15.5 | 16.5 | 6.5 |
| Compression st | 17.7 | 9.62 | −45.6 |
| (25%, 22 hours, | | | |
| 70 C.) | | | |
| Rebound (DIN | 15-16 | 18-20 | 22.6 |
| 53512) | | | |

The test work reported above reveals and unexpectedly large, but highly desirable, improvement in the properties of tear strength, compression set, and rebound as a result of the addition of HFO-1233zd(E) at a concentration of 2 php, with no substantial deterioration in other foam properties.

### Example 9B

### Water and HFO-1234yf Blowing Agent in Shoe Sole Foam

Example 9A is repeated except that the 1233zd component of the physical blowing agent is replaced on a mole for mole basis with 1234yf. An integral skin foam is formed.

### Example 9C

### Water and TransHFO-1234ze Blowing Agent in Shoe Sole Foam

Example 9A is repeated except that the 1233zd component physical blowing agent is replaced on a mole for mole basis with transHFO-1234ze. An integral skin foam is formed.

### Example 9D

### Water and HFO-1233xf Blowing Agent in Shoe Sole Foam

Example 9A is repeated except that the 1233zd component of the physical blowing agent is replaced on a mole for mole basis with HFO-1233xf. An integral skin foam is formed.

### Example 9E

### Water and HFO-1336mmz Blowing Agent in Integral Skin Foam

Example 9A is repeated except that the 1233zd component physical blowing agent is replaced on a mole for mole basis with HFO-1336mmz. An integral skin foam is formed.

### Comparative Example E

### Water as Blowing Agent in for Mid-Sole Shoe Sole Integral Skin Foam

Comparative Example D is repeated except that the molding operation is adjusted by overpacking to achieve an increase in overall (core plus skin) density. The shoe sole test plates thus formed are tested (18×12×2 cm is used for compression set determination and the 18×25×1 cm is used for all other tests) and found to have the following properties in Table CEE (each value being understood as being modified by “about”):

TABLE CEE

| | |
|---|---|
| Density (pcf) | 21.9 |
| Shore A | 44-47 |
| Hardness | |
| Elongation | 950 |
| Tensile | 3.4 |
| Strength | |
| Tear Strength | 16.5 |
| Compression | 16.9 |
| st (25%, 22 | |
| hours, 70 C.) | |
| Rebound (DIN | 16-17 |
| 53512) | |

### Example 10A

### Water Plus 1233ZD(E)AS Blowing Agent in for Mid-Sole Shoe Sole Integral Skin Foam

Comparative Example E is repeated except that the ISO component was modified to include 2% (i.e., 2 php) of HFO-1233zd(E) and the amount of water was reduced to 0.7 php, and the amount of foamable composition was increased to overpack the mold to achieve the same density as produced in Comparative Example E. The shoe sole test plates thus formed are tested as in Comparative Example E and found to have the following properties in Table 10, with the values from Table CEE being repeated for convenience (each value being understood as being modified by “about”):

TABLE 10

| Example>> | | | |
|---|---|---|---|
| Property | Comparative | Example | Improvement |
| ▾ ▾ | Example E | 9 | (%) |
| Density (pcf) | 21.9 | 21.9 | |
| Shore A | 44-47 | 44-47 | 0 |
| Hardness | | | |
| Elongation | 950 | 940 | −1.1 |
| Tensile Strength | 3.4 | 3.5 | 2.9 |
| Tear Strength | 16.5 | 18.9 | 14.5 |
| Compression st | 16.9 | 7.54 | −55.4 |
| (25%, 22 hours, | | | |
| 70 C.) | | | |
| Rebound (DIN | 16-17 | 19-20 | 18.2 |
| 53512) | | | |

The test work reported above reveals and unexpectedly large, but highly desirable, improvement in the properties of tear strength, compression set, and rebound as a result of the addition of HFO-1233zd(E) at a concentration of 2 php, with no substantial deterioration in other foam properties.

### Example 10B

### Water and HFO-1234yf Blowing Agent in Shoe Sole Foam

Example 10A is repeated except that the 1233zd component of the physical blowing agent is replaced on a mole for mole basis with 1234yf. An integral skin foam is formed.

### Example 10C

### Water and TransHFO-1234ze Blowing Agent in Shoe Sole Foam

Example 10A is repeated except that the 1233zd component physical blowing agent is replaced on a mole for mole basis with transHFO-1234ze. An integral skin foam is formed.

### Example 10D

### Water and HFO-1233xf Blowing Agent in Shoe Sole Foam

Example 10A is repeated except that the 1233zd component of the physical blowing agent is replaced on a mole for mole basis with HFO-1233xf. An integral skin foam is formed.

### Example 10E

### Water and HFO-1336mmz Blowing Agent in Integral Skin Foam

Example 10A is repeated except that the 1233zd component physical blowing agent is replaced on a mole for mole basis with HFO-1336mmz. An integral skin foam is formed.

### Comparative Example F

### Water as Blowing Agent in for Shoe Sole Integral Skin Foam

A polyol premix formulation is made up of: 100 parts by weight of polyol 91610 and 16.93 parts per hundred parts of polyol by weight (hereinafter referred to as “php”) of product sold under the trade designation Elastopan S7089/144 sold by BASF which includes catalyst, chain extender, water and surfactant, thus providing about 0.5 php of water. The ISO component consisted of ISO 187/73 (prepolymer Isocyanate, 17.7% NCO) in an amount to provide an Index of 100 (ratio of polyol/ISO of 65.5/69.5). The well mixed polyol blend (polyol plus Elastospan) and the isocyanate prepolymer were added to the A and B tank of a DESMA foaming machine. The integral skin shoe sole foam thus formed was tested and found to have the following properties as reported in Table CEF (each value being understood as being modified by “about”):

TABLE CEF

| | |
|---|---|
| Density (pcf) | 29.3 |
| Shore A | 42-45 |
| Hardness | |
| Elongation | 692 |
| Tensile | 3.3 |
| Strength | |
| Tear Strength | 31.9 |
| Compression | 47.7 |
| st (25%, 22 | |
| hours, 70 C.) | |

### Example 11A

### Water Plus 1233ZD(E)AS Blowing Agent in for Shoe Sole Integral Skin Foam

Comparative Example F is repeated except that the ISO component was modified to include 2% (i.e., 2 php) of HFO-1233zd(E) and 1.5 php of ethylene glycol chain extender and 0.8 php of Tagostab B8948 surfactant/cell opener were added to add dimensional stability to the foam. The ratio of polyol component to iso component was 67/74.6 to produce the same Index (100) as Comparative Example F. The foam thus formed is tested as in Comparative Example F and found to have the following properties in Table 11, with the values from Table CEF being repeated for convenience (each value being understood as being modified by “about”):

TABLE 11

| Example>> | | | |
|---|---|---|---|
| Property | Comparative | Example | Improvement |
| ▾ ▾ | Example E | 9 | (%) |
| Density (pcf) | 29.3 | 23.6 | −19 |
| Shore A | 42-45 | 40-42 | −6 |
| Hardness | | | |
| Elongation | 692 | 1048 | 57 |
| Tensile Strength | 3.3 | 5.3 | 67 |
| Tear Resistance | 31.9 | 26.3 | −16 |
| Compression st | 47.7 | 51 | 10 |
| (25%, 22 hours, | | | |
| 70 C.) | | | |

The test work reported above reveals and unexpectedly large, but highly desirable, improvement (reduction) in overall density and in the properties of tensile strength and elongation at break as a result of the addition of HFO-1233zd(E) at a concentration of 2 php, with no substantial deterioration in other foam properties as reported in the table, except tear resistance which deteriorated by 16%.

### Example 11B

### Water and HFO-1234yf Blowing Agent in Shoe Sole Foam

Example 11A is repeated except that the 1233zd component of the physical blowing agent is replaced on a mole for mole basis with 1234yf. An integral skin foam is formed.

### Example 11C

### Water and TransHFO-1234ze Blowing Agent in Shoe Sole Foam

Example 11A is repeated except that the 1233zd component physical blowing agent is replaced on a mole for mole basis with transHFO-1234ze. An integral skin foam is formed.

Example 11D

### Water and HFO-1233xf Blowing Agent in Shoe Sole Foam

Example 11A is repeated except that the 1233zd component of the physical blowing agent is replaced on a mole for mole basis with HFO-1233xf. An integral skin foam is formed.

### Example 11E

### Water and HFO-1336mmz Blowing Agent in Integral Skin Foam

Example 11A is repeated except that the 1233zd component physical blowing agent is replaced on a mole for mole basis with HFO-1336mmz. An integral skin foam is formed.

### Example 12

### Water Plus 1233ZD(E)AS Blowing Agent in for Shoe Sole Integral Skin Foam

Example 11 is repeated except that the ISO component was further modified to include 0.5 php of 1,4-butanediol as a further chain extender. The ratio of polyol component to iso component was maintained at 67/74.6 to produce the same Index (100). The foam thus formed is tested as in Comparative Example F and found to have the following properties in Table 12, with the values from Table CEF being repeated for convenience (each value being understood as being modified by “about”):

TABLE 12

| Example>> | | | |
|---|---|---|---|
| Property | Comparative | Example | Improvement |
| ▾ ▾ | Example E | 9 | (%) |
| Density (pcf) | 29.3 | 23.6 | −19 |
| Shore A | 42-45 | 40-42 | −6 |
| Hardness | | | |
| Elongation | 692 | 1087 | 51 |
| Tensile Strength | 3.3 | 5.5 | 61 |
| Tear Resistance | 31.9 | 30.4 | −5 |
| Compression st | 47.7 | 51.8 | 9 |
| (25%, 22 hours, | | | |
| 70 C.) | | | |

The test work reported above reveals and unexpectedly large, but highly desirable, improvement (reduction) in overall density and in the properties of tensile strength and elongation at break as a result of the addition of HFO-1233zd(E) at a concentration of 2 php, with no substantial deterioration in other foam properties as reported in the table, including a substantial improvement in tear resistance as a result of the addition of a supplemental chain extender butanediol.

### Example 12B

### Water and HFO-1234yf Blowing Agent in Shoe Sole Foam

Example 12A is repeated except that the 1233zd component of the physical blowing agent is replaced on a mole for mole basis with 1234yf. An integral skin foam is formed.

### Example 12C

### Water and transHFO-1234ze Blowing Agent in Shoe Sole Foam

Example 12A is repeated except that the 1233zd component physical blowing agent is replaced on a mole for mole basis with transHFO-1234ze. An integral skin foam is formed.

### Example 12D

### Water and HFO-1233xf Blowing Agent in Shoe Sole Foam

Example 12A is repeated except that the 1233zd component of the physical blowing agent is replaced on a mole for mole basis with HFO-1233xf. An integral skin foam is formed.

### Example 12E

### Water and HFO-1336mmz Blowing Agent in Integral Skin Foam

Example 12A is repeated except that the 1233zd component physical blowing agent is replaced on a mole for mole basis with HFO-1336mmz. An integral skin foam is formed.

### Comparative Example G

### Water as Blowing Agent for Mid-Sole Shoe Sole Integral Skin Foam

A polyol premix formulation is made up of: 100 parts by weight of a polyol blend; 5 parts per hundred parts of polyol by weight (hereinafter referred to as “php”) of chain extender consisting of monoethylene glycol; 3.6 php of chain extender consisting of diethylene glycol; 1.5 php of catalyst (33% triethyleneamine in ethylene glycol sold by AirProducts as DABCO 33EG; 0.1 php of bis-(2-dimethylaminoethyl)ether catalyst; and 1.3 php water as chemical blowing agent. The polyol blend consisted of 50 parts by weight of C2801 and 50 php of P3021. The ISO component consisted of ISN 42 in an amount to provide an Index of 100 (105 php). The POLYOL component (maintained at 35° C.) and the ISO component (maintained at 50° C.) are then introduced to a low pressure pouring machine made by PU MIX srl with an output of 40 g/s. A mixing speed of 7000 rpm was used to prepare shoe sole sample for physical property testing. The test plate was made in an aluminum mold at 50° C. for each of two different sizes: 18×12×2 cm (used for compression set determination) and 18×25×1 cm (used for all other tests). The shoe sole test plates thus formed are tested (18×12×2 cm is used for compression set determination and the 18×25×1 cm is used for all other tests) and found to have the following properties in Table CEG (each value being understood as being modified by “about”):

TABLE CEG

| | |
|---|---|
| Density (pcf) | 15.6 |
| Shore A | 30 |
| Hardness | |
| Elongation | 400 |
| Tensile | 1.6 |
| Strength | |
| Tear Strength | 6.6 |
| Compression | 19.2 |
| st (25%, 22 | |
| hours, 70 C.) | |
| Rebound (DIN | 32-33 |
| 53512) | |

### Example 13A

### Water Plus 1233ZD(E)AS Blowing Agent in for Mid-Sole Shoe Sole Integral Skin Foam

Comparative Example G is repeated except that the ISO component was modified to include 3% (i.e., 3 php) of HFO-1233zd(E) and the amount of water was reduced to 1 php, and the amount of foamable composition was increased to overpack the mold to achieve the same density as produced in Comparative Example G. The shoe sole test plates thus formed are tested as in Comparative Example G and found to have the following properties in Table 13, with the values from Table CEG being repeated for convenience (each value being understood as being modified by “about”):

TABLE 13

| Example>> | | | |
|---|---|---|---|
| Property | Comparative | Example | Improvement |
| ▾ ▾ | Example G | 13 | (%) |
| Density (pcf) | 15.6 | 15.6 | |
| Shore A | 30 | 32 | 7 |
| Hardness | | | |
| Elongation | 400 | 356 | −11 |
| Tensile Strength | 1.6 | 1.7 | 6 |
| Tear Strength | 6.6 | 8.3 | 26 |
| Compression st | 19.2 | 18.3 | −5 |
| (25%, 22 hours, | | | |
| 70 C.) | | | |
| Rebound (DIN | 32-33 | 32-33 | 0 |
| 53512) | | | |

The test work reported above reveals and unexpectedly large, but highly desirable, improvement in the properties of hardness and tear strength as a result of the addition of HFO-1233zd(E) at a concentration of 3 php.

### Example 13B

### Water and HFO-1234yf Blowing Agent in Shoe Sole Foam

Example 13A is repeated except that the 1233zd component of the physical blowing agent is replaced on a mole for mole basis with 1234yf. An integral skin foam is formed.

### Example 13C

### Water and TransHFO-1234ze Blowing Agent in Shoe Sole Foam

Example 13A is repeated except that the 1233zd component physical blowing agent is replaced on a mole for mole basis with transHFO-1234ze. An integral skin foam is formed.

### Example 13D

### Water and HFO-1233xf Blowing Agent in Shoe Sole Foam

Example 13A is repeated except that the 1233zd component of the physical blowing agent is replaced on a mole for mole basis with HFO-1233xf. An integral skin foam is formed.

### Example 13E

### Water and HFO-1336mmz Blowing Agent in Integral Skin Foam

Example 13A is repeated except that the 1233zd component physical blowing agent is replaced on a mole for mole basis with HFO-1336mmz. An integral skin foam is formed.

### Example 14A

### Water Plus 1233ZD(E)AS Blowing Agent in for Mid-Sole Shoe Sole Integral Skin Foam

Comparative Example G is repeated except that the ISO component was modified to include 5% (i.e., 5 php) of HFO-1233zd(E) and the amount of water was reduced to 1 php, and the amount of foamable composition was increased to overpack the mold to achieve the same density as produced in Comparative Example G. The shoe sole test plates thus formed are tested as in Comparative Example G and found to have the following properties in Table 14, with the values from Table CEG being repeated for convenience (each value being understood as being modified by “about”):

TABLE 14

| Example>> | | | |
|---|---|---|---|
| Property | Comparative | Example | Improvement |
| ▾ ▾ | Example G | 14 | (%) |
| Density (pcf) | 15.6 | 15.6 | |
| Shore A | 30 | 31 | 7 |
| Hardness | | | |
| Elongation | 400 | 340 | −11 |
| Tensile Strength | 1.6 | 1 | 6 |
| Tear Strength | 6.6 | 6.2 | 26 |
| Compression st | 19.2 | 19.4 | −5 |
| (25%, 22 hours, | | | |
| 70 C.) | | | |
| Rebound (DIN | 32-33 | 33-34 | 0 |
| 53512) | | | |

The test work reported above reveals and unexpectedly large, but highly desirable, improvement in the properties of hardness and tear strength as a result of the addition of HFO-1233zd(E) at a concentration of 5 php.

### Example 14B

### Water and HFO-1234yf Blowing Agent in Shoe Sole Foam

Example 14A is repeated except that the 1233zd component of the physical blowing agent is replaced on a mole for mole basis with 1234yf. An integral skin foam is formed.

### Example 14C

### Water and TransHFO-1234ze Blowing Agent in Shoe Sole Foam

Example 14A is repeated except that the 1233zd component physical blowing agent is replaced on a mole for mole basis with transHFO-1234ze. An integral skin foam is formed.

### Example 14D

### Water and HFO-1233xf Blowing Agent in Shoe Sole Foam

Example 14A is repeated except that the 1233zd component of the physical blowing agent is replaced on a mole for mole basis with HFO-1233xf. An integral skin foam is formed.

### Example 14E

### Water and HFO-1336mmz Blowing Agent in Integral Skin Foam

Example 14A is repeated except that the 1233zd component physical blowing agent is replaced on a mole for mole basis with HFO-1336mmz. An integral skin foam is formed.

### Example 15

### Catalyst Stability

After testing of the stability of various catalysts with trans1233zd(E) in numerous ISF formulations and shoe sole formulation, the following amine catalyst have been found to be highly stable after long term storage in polyol premix formulations: DM70; Polycat 8 or PC 8, which is a DMCHA tertiary amine catalyst available from AirProducts; Polycat 12 or PC 12, which is a tertiary amine catalyst available from AirProducts; JeffCat ZF-10 which is an amine catalyst available from Huntsman. The following fully acid blocked amine catalyst have also been found to be highly stable after long term storage in polyol premix formulations: Jeffcat LED 103 from Hunstman; Polycat SA-1 from Airproducts; and Polycat 204 from Airproducts.

1. An integral skin foam comprising:
(a) a substantially non-cellular, relatively high density polyurethane skin; and
(b) a substantially closed-cell, relatively low-density polyurethane foam core integrally attached to said skin, said closed-cells of said core containing blowing agent comprising physical blowing agent comprising in major proportion by weight at least one trifluoro, monochloropropene (HFO-1233) and/or at least one hexafluorobutene (HFO-1336), said foam having a core density of not greater than about 20 pounds per cubic foot (pcf) and the skin layer has a Shore A hardness of not less than about 35.

2. The integral skin foam of claim 1 wherein said physical blowing agent consists essentially of transHFO-1233zd.

3. The integral skin foam of claim 1 wherein the foam has a core density of not greater than about 15 pcf.

4. The integral skin foam of claim 1 wherein the skin layer has a Shore A hardness of not less than about 45.

5. The integral skin foam of claim 3 wherein the skin layer has a Shore A hardness of not less than about 45.

6. The integral skin foam of claim 1 wherein the skin layer has a Shore A hardness of not less than about 50.

7. A shoe sole comprising an integral skin foam comprising:
(a) a substantially non-cellular, relatively high density polyurethane skin; and
(b) a substantially closed-cell, relatively low-density polyurethane foam core integrally attached to said skin, said closed-cells of said core containing blowing agent comprising: (i) physical blowing agent comprising in major proportion by weight of transHFO-1233zd, wherein the foam has an overall density of not greater than about 20 pounds per cubic foot (pcf) and the skin layer has a Shore C hardness of not less than about 75.

8. The shoe sole of claim 7 wherein said physical blowing agent consists essentially of transHFO-1233zd.

9. The shoe sole wherein the foam has an overall density of not greater than about 15 pcf.

10. An article of manufacture comprising a footware body and a footware sole comprising an integral skin foam according to claim 1.

11. A method of making integral skin foam comprising:
providing a foamable composition comprising: (a) one or more polyols; (b) at least one isocyanate reactive with said polyols; (c) one or more surfactants; (d) one or more catalysts; and (e) at least one physical blowing agent comprising in major proportion by weight one or more fluorochloropropenes and/or hexafluorobutenes; and (f) optionally a chemical blowing agent; and
molding said foamable composition into an integral skin foam having (i) a substantially non-cellular, relatively high density polyurethane skin; and (ii) a substantially closed-cell, relatively low-density polyurethane foam core integrally attached to said skin, said closed-cells of said core containing at least said physical blowing agent, wherein said foam has a core density of not greater than about 20 pounds per cubic foot (pcf) and the skin layer has a Shore A hardness of not less than about 35.

12. The method of claim 11 wherein the skin layer has a Shore A hardness of not less than about 40.

13. The method of claim 11 wherein the physical blowing agent consists essentially of transHFO-1233zd.

14. The method of claim 13 wherein the foam has a core density of not greater than about 15 pcf and the skin layer has a Shore A hardness of not less than about 45.

15. The method of claim 14 wherein the skin layer has a Shore A hardness of not less than 50.

16. The method of claim 11 wherein said foamable composition further comprises functionality of about 3 and a molecular weight of from about 500 to about 4500.

17. The method of claim 16 wherein said foamable composition further comprises at least one chain extender and at least one surfactant.

18. The method of claim 16 wherein said foamable composition comprises a chemical blowing agent.

19. The method of claim 18 wherein said chemical blowing agent comprises water.

20. An integral skin foam formed by the method of claim 11.
